(19) United States
(12) Patent Application Publication
(10) Pub. No.: US 2025/0243110 A1
(43) Pub. Date: Jul. 31, 2025

(54) CURABLE COMPOSITION, UNDERCOAT LAYER, LAMINATE, AND DISPLAY DEVICE

(71) Applicant: DAICEL CORPORATION, Osaka (JP)

(72) Inventors: Yusaku SAINOHIRA, Tokyo (JP); Masashi YOKOYAMA, Tokyo (JP); Tsubasa MIKI, Tokyo (JP)

(73) Assignee: DAICEL CORPORATION, Osaka (JP)

(21) Appl. No.: 19/034,317

(22) Filed: Jan. 22, 2025

(30) Foreign Application Priority Data
Jan. 26, 2024 (JP) 2024-010566

(51) Int. Cl. C03C 17/34

(52) U.S. Cl. CPC C03C 17/3405; C03C 2217/78

(57) ABSTRACT

Object

An object is to provide a curable composition having excellent adhesion to a substrate and a hard coat layer and capable of forming a layer exhibiting high surface hardness when the hard coat layer is laminated.

Solution

A curable composition of the present disclosure is characterized by containing, as curable compounds, a first epoxy compound that is an organosiloxane containing two or more alicyclic epoxy groups, a second epoxy compound, a polyorganosiloxane including a silanol group, and a third epoxy compound or an oxetane compound. In addition, the curable composition preferably contains the first epoxy compound, the second epoxy compound, the polyorganosiloxane including a silanol group, and the oxetane compound.

### TECHNICAL FIELD

The present disclosure relates to a curable composition, an undercoat layer composed of a cured product of the curable composition, a laminate, and a display device.

### BACKGROUND ART

A configuration in which a hard coat layer is provided on a surface of an article (substrate) is known. The purpose of having this configuration is to improve the scratch resistance (i.e. characteristics of the material to protect itself from being damaged when rubbed and/or scratched) of the surface of the article (substrate) whose transparency and/or appearance plays an important role, such as a display of a TV set, a personal computer, a smartphone, or the like, or a film for a display of those.

In particular, a configuration in which an undercoat layer (interlayer adhesive layer) is provided between a substrate and a hard coat layer is known. This is to exhibit adhesion between the substrate and the hard coat layer (e.g., Patent Document 1).

### CITATION LIST

### Patent Document

Patent Document 1: JP 2003-055601 A

### SUMMARY OF INVENTION

### Technical Problem

However, despite the use of an undercoat layer, there has still been a problem of insufficient adhesion between an undercoat layer and a hard coat layer having a specific composition.

In addition, increasing the adhesion to the substrate and the hard coat layer tends to reduce the surface hardness when the hard coat layer is laminated, and it has been difficult to achieve both the adhesion to the substrate and the hard coat layer and the high surface hardness.

The present disclosure is to solve the above problems, and an object of the present disclosure is to provide a curable composition having excellent adhesion to a substrate and a hard coat layer and capable of forming a layer exhibiting high surface hardness when the hard coat layer is laminated.

### Solution to Problem

The inventors of the present disclosure have found that a curable composition containing, as curable compounds, a first epoxy compound that is an organosiloxane containing two or more alicyclic epoxy groups, a second epoxy compound, a polyorganosiloxane including a silanol group, and a third epoxy compound or an oxetane compound has excellent adhesion to a substrate and a hard coat layer, and exhibits high surface hardness when the hard coat layer is laminated. The present disclosure has been completed based on these findings.

That is, the present disclosure provides a curable composition containing, as curable compounds, a first epoxy compound that is an organosiloxane containing two or more alicyclic epoxy groups, a second epoxy compound, a polyorganosiloxane including a silanol group, and a third epoxy compound or an oxetane compound.

The curable composition preferably contains the first epoxy compound, the second epoxy compound, the polyorganosiloxane including a silanol group, and the oxetane compound.

In the curable composition, a content of the first epoxy compound is preferably from 30 to 70 mass % per a total amount of the curable compounds.

In the curable composition, a content of the second epoxy compound is preferably from 20 to 60 mass % per a total amount of the curable compounds.

In the curable composition, a content of the oxetane compound is preferably from 5 to 25 mass % per a total amount of the curable compounds.

In the curable composition, a content of the polyorganosiloxane including a silanol group is preferably from 1 to 15 mass % per a total amount of the curable compounds.

The curable composition preferably contains no deleterious substance.

The curable composition preferably contains no compound corresponding to a PFAS.

In addition, the present disclosure provides an undercoat layer containing a cured product of the curable composition.

The undercoat layer preferably has a thickness of 0.1 to 20 μm.

In addition, the present disclosure provides a laminate in which a substrate, the undercoat layer formed on at least one surface of the substrate, and a hard coat layer are laminated in this order.

In the laminate, the substrate is preferably a glass substrate.

In the laminate, the hard coat layer preferably contains a curing-type polyorganosilsesquioxane resin as a curing-type resin.

In the laminate, pencil hardness of the hard coat layer surface is 3H or more.

In the laminate, when cuts are made at intervals of 1 mm to form a lattice pattern of 100 squares on the surface of the hard coat layer, and an adhesive tape is attached and peeled off at an angle of 90°, 90 or more squares preferably remain intact.

In the laminate, the hard coat layer preferably contains no compound corresponding to a PFAS.

In addition, the present disclosure provides an image display device including the laminate.

### Advantageous Effects of Invention

The curable composition of the present disclosure has excellent adhesion to a substrate and a hard coat layer and can form a layer exhibiting high surface hardness when the hard coat layer is laminated.

### BRIEF DESCRIPTION OF DRAWINGS

FIG. 1 is a chart showing a ²⁹Si-NMR spectrum of an embodiment of a polyorganosiloxane including a silanol group.

### DESCRIPTION OF EMBODIMENTS

In the present disclosure, a “(meth)acryloyl group” means an acryloyl group and/or a methacryloyl group. “(Meth)acrylate” means acrylate and/or methacrylate.

Curable Composition A curable composition of the present disclosure contains, as curable compounds, a first epoxy compound that is an organosiloxane containing two or more alicyclic epoxy groups, a second epoxy compound, a polyorganosiloxane including a silanol group, and a third epoxy compound or an oxetane compound.

In addition, the curable composition may be a photocurable composition, a thermosetting composition, or a curable composition with both photocurability and thermosetting properties. Among these, the curable composition is preferably a photocurable composition.

### Organosiloxane Containing Two or More Alicyclic Epoxy Groups (First Epoxy Compound)

The curable composition contains the first epoxy compound that is an organosiloxane containing two or more alicyclic epoxy groups. The first epoxy compound is a compound having two or more alicyclic epoxy groups per molecule and further having at least a siloxane backbone composed of a siloxane bond (Si—O—Si). Examples of the siloxane backbone include a cyclic siloxane backbone, a linear or branched silicone (linear or branched polysiloxane), and a cage or ladder polysilsesquioxane. In the present disclosure, among these, a compound having a cyclic siloxane backbone is preferred in terms of achieving both ease of application and adhesion to a substrate. One type of the first epoxy compound can be used, or two or more types can be used.

In addition, in the case where the first epoxy compound has a cyclic siloxane backbone, the number of Si—O units forming the siloxane ring (the number is equal to the number of silicon atoms forming the siloxane ring) is preferably from 2 to 12 and more preferably from 4 to 8.

The proportion of a silanol group in the first epoxy compound is preferably less than 5%, more preferably 1% or less, and even more preferably 0%. That is, the first epoxy compound preferably contains no silanol group. The proportion of a silanol group can be measured by a method similar to that for measuring a polyorganosiloxane including a silanol group described below.

The number average molecular weight (Mn) of the first epoxy compound determined by gel permeation chromatography and calibrated with standard polystyrene is not particularly limited but is, for example, preferably from 200 to less than 3000, more preferably from 300 to 2000, and even more preferably from 400 to 800.

In addition, the alicyclic epoxy group of the first epoxy compound means a cyclic olefin group epoxidized in the molecule. The “cyclic olefin group epoxidized” is a group (monovalent group) formed with one hydrogen atom removed from a structure in which at least one of carbon-carbon unsaturated bonds contained in the cyclic olefin (a cycloaliphatic hydrocarbon in which at least one of carbon-carbon bonds forming the ring is a carbon-carbon unsaturated bond) is epoxidized. That is, the epoxidized cyclic olefin group is a group containing an aliphatic hydrocarbon ring structure and an epoxy group in which the epoxy group is composed of two adjacent carbon atoms and an oxygen atom constituting the aliphatic hydrocarbon ring.

Examples of the cyclic olefin group (in the form before epoxidation) in the epoxidized cyclic olefin group include a cycloalkenyl group, such as a cyclopropenyl group (e.g., such as a 2-cyclopropen-1-yl group), a cyclobutenyl group (e.g., such as a 2-cyclobuten-1-yl group), a cyclopentenyl group (e.g., such as a 2-cyclopenten-1-yl group and a 3-cyclopenten-1-yl group), and a cyclohexenyl group (e.g., such as a 2-cyclohexen-1-yl group and a 3-cyclohexen-1-yl group); a cycloalkadienyl group, such as a 2,4-cyclopentadien-1-yl group, a 2,4-cyclohexadien-1-yl group, and a 2,5-cyclohexadien-1-yl group; and a polycyclic group, such as a dicyclopentenyl group, a dicyclohexenyl group, and a norbornenyl group.

One or more substituents may be bonded to the aliphatic hydrocarbon ring forming the cyclic olefin group in the epoxidized cyclic olefin group. Examples of the substituent include substituents having from 0 to 20 carbons (more preferably from 0 to 10 carbons) and more specifically include a halogen atom, such as a fluorine atom, a chlorine atom, a bromine atom, and an iodine atom; a hydroxy group; an alkoxy group (preferably a C₁₋₆ alkoxy group and more preferably a C₁₋₄ alkoxy group), such as a methoxy group, an ethoxy group, a propoxy group, an isopropyloxy group, a butoxy group, and an isobutyloxy group; an alkenyloxy group (preferably a C₂₋₆ alkenyloxy group and more preferably a C₂₋₄ alkenyloxy group), such as an allyloxy group; an aryloxy group (preferably a C₆₋₁₄ aryloxy group) that may have a substituent, such as a C₁₋₄ alkyl group, a C₂₋₄ alkenyl group, a halogen atom, or a C₁₋₄ alkoxy group, on an aromatic ring, such as a phenoxy group, a tolyloxy group, and a naphthyloxy group; an aralkyloxy group (preferably a C₇₋₁₈ aralkyloxy group), such as a benzyloxy group and a phenethyloxy group; an acyloxy group (preferably a C₁₋₁₂ acyloxy group), such as an acetyloxy group, a propionyloxy group, a (meth)acryloyloxy group, and a benzoyloxy group; a mercapto group; an alkylthio group (preferably a C₁₋₆ alkylthio group and more preferably a C₁₋₄ alkylthio group), such as a methylthio group and an ethylthio group; an alkenylthio group (preferably a C₂₋₆ alkenylthio group and more preferably a C₂₋₄ alkenylthio group), such as an allylthio group; an arylthio group (preferably a C₆₋₁₄ arylthio group) that may have a substituent, such as a C₁₋₄ alkyl group, a C₂₋₄ alkenyl group, a halogen atom, or a C₁₋₄ alkoxy group, on an aromatic ring, such as a phenylthio group, a tolylthio group, and a naphthylthio group; an aralkylthio group (preferably a C₇₋₁₈ aralkylthio group), such as a benzylthio group and a phenethylthio group; a carboxy group; an alkoxycarbonyl group (preferably a C₁₋₆ alkoxy-carbonyl group), such as a methoxycarbonyl group, an ethoxycarbonyl group, a propoxycarbonyl group, and a butoxycarbonyl group; an aryloxycarbonyl group (preferably a C₆₋₁₄ aryloxy-carbonyl group), such as a phenoxycarbonyl group, a tolyloxycarbonyl group, and a naphthyloxycarbonyl group; an aralkyloxycarbonyl group (preferably a C₇₋₁₈ aralkyloxy-carbonyl group), such as a benzyloxycarbonyl group; an amino group; a mono- or dialkylamino group (preferably a mono- or di-C₁₋₆ alkylamino group), such as a methylamino group, an ethylamino group, a dimethylamino group, and a diethylamino group; an acylamino group (preferably a C₁₋₁₁ acylamino group), such as an acetylamino group, a propionylamino group, and a benzoylamino group; an oxetanyl group-containing group, such as an ethyloxetanyloxy group; an acyl group, such as an acetyl group, a propionyl group, and a benzoyl group; an oxo group; and a group in which two or more of these are bonded via a C₁₋₆ alkylene group as necessary.

Among these, the cyclic olefin group is preferably a cyclic olefin group having from 5 to 12 carbons, more preferably a cycloalkenyl group having from 5 to 12 carbons, and even more preferably a cyclohexenyl group. That is, the epoxidized cyclic olefin group is preferably a group in which a cyclic olefin group having from 5 to 12 carbons is epoxidized, more preferably a group in which a cycloalkenyl group having from 5 to 12 carbons is epoxidized, and even more preferably a group in which a cyclohexenyl group is epoxidized (cyclohexeneoxide group). The first epoxy compound may have one type or two or more types of epoxidized cyclic olefin groups.

The number of epoxidized cyclic olefin groups contained in the molecule of the first epoxy compound is 2 or more and is not particularly limited but is preferably from 2 to 6, more preferably from 3 to 5, and even more preferably 4.

Examples of the first epoxy compound include 2,4-di[2-(3-{oxabicyclo[4.1.0]heptyl})ethyl]-2,4,6,6,8,8-hexamethyl-cyclotetrasiloxane, 4,8-di[2-(3-{oxabicyclo[4.1.0]heptyl})ethyl]-2,2,4,6,6,8-hexamethyl-cyclotetrasiloxane, 2,4-di[2-(3-{oxabicyclo[4.1.0]heptyl})ethyl]-6,8-dipropyl-2,4,6,8-tetramethyl-cyclotetrasiloxane, 4,8-di[2-(3-{oxabicyclo[4.1.0]heptyl})ethyl]-2,6-dipropyl-2,4,6,8-tetramethyl-cyclotetrasiloxane, 2,4,8-tri[2-(3-{oxabicyclo[4.1.0]heptyl})ethyl]-2,4,6,6,8-pentamethyl-cyclotetrasiloxane, 2,4,8-tri[2-(3-{oxabicyclo[4.1.0]heptyl})ethyl]-6-propyl-2,4,6,8-tetramethyl-cyclotetrasiloxane, 2,4,6,8-tetra[2-(3-{oxabicyclo[4.1.0]heptyl})ethyl]-2,4,6,8-tetramethyl-cyclotetrasiloxane, and silsesquioxane having an epoxy group.

The content of the first epoxy compound in the curable composition of the present disclosure is preferably from 30 to 70 mass %, more preferably from 35 to 65 mass %, and even more preferably from 40 to 60 mass % per a total amount (100 mass %) of the curable compounds. The content within the above ranges enables the curable composition to be easily applied to a substrate and further allows the coated substrate to have excellent adhesion.

### Second Epoxy Compound

The curable composition contains an additional epoxy compound besides the first epoxy compound and a polyorganosiloxane including a silanol group described later (hereinafter, the additional epoxy compound may be referred to as “the second epoxy compound”). Containing the second epoxy compound enables the curable composition to be easily applied to a substrate.

Examples of the second epoxy compound include an alicyclic epoxy compound other than the first epoxy compound, an aliphatic epoxy compound, and an aromatic epoxy compound. The second epoxy compound is preferably an alicyclic epoxy compound from the viewpoint of exhibiting ease of application to a substrate in combination with the first epoxy compound.

Examples of the additional alicyclic epoxy compound include a compound represented by Formula (a1) below.

[Chem. 1]

R—X—R (a1)

In Formula (a1) above, R represents an epoxidized cyclic olefin group as described above. Two Rs may be the same or different. X represents a single bond or a linking group (a divalent group having one or more atoms; excluding a group containing a siloxane bond). Examples of the linking group include a divalent hydrocarbon group, a carbonyl group, an ether bond, an ester bond, a carbonate group, an amide group, and a group in which a plurality of these is linked. Examples of the divalent hydrocarbon group include a divalent aliphatic hydrocarbon group, a divalent alicyclic hydrocarbon group, and a group in which a plurality of these is bonded. Examples of the divalent aliphatic hydrocarbon group include a linear or branched alkylene group (e.g., an alkylene group having from 1 to 6 carbons), such as a methylene group, a methylmethylene group, a dimethylmethylene group, an ethylene group, a propylene group, a trimethylene group, and a tetramethylene group. In addition, examples of the divalent alicyclic hydrocarbon group include a divalent cycloalkylene group, such as a 1,2-cyclopentylene group, a 1,3-cyclopentylene group, a 1,2-cyclohexylene group, a 1,3-cyclohexylene group, and a 1,4-cyclohexylene group. Examples of the compound represented by Formula (a1) above include a compound in which two Rs are both cyclohexeneoxide groups (in particular, such as a compound in which carbon atoms at the 4-positions of two cyclohexeneoxide groups (positions of two carbon atoms forming an epoxy group are designated as the 1-position and the 2-position) are linked by a single bond or a divalent hydrocarbon group).

Examples of the alicyclic epoxy compound represented by Formula (a1) above specifically include (3,4,3′,4′-diepoxy)bicyclohexyl, bis(3,4-epoxycyclohexylmethyl)ether, 1,2-epoxy-1,2-bis(3,4-epoxycyclohexan-1-yl)ethane, 2,2-bis(3,4-epoxycyclohexan-1-yl)propane, 1,2-bis(3,4-epoxycyclohexan-1-yl)ethane, bis(3,4-epoxycyclohexylmethyl)ether, 3′,4′-epoxycyclohexylmethyl, and 3,4-epoxycyclohexane carboxylate.

In addition, the additional alicyclic epoxy compound also includes a compound, such as a compound represented by Formula (b1) below, in which an epoxy group is directly bonded to an alicyclic ring via a single bond, and a hydrogenated aromatic glycidyl ether-based epoxy compound.

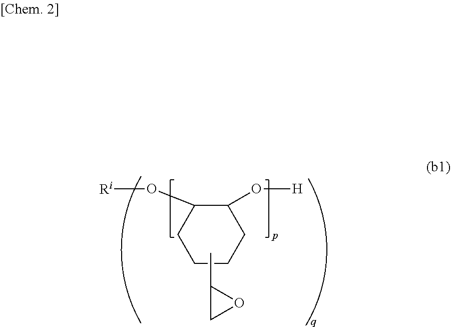

In Formula (b1), R is a group which is a q-hydric alcohol with q OH groups removed, and p and q each represent a natural number. Examples of the q-hydric alcohol [Rⁱ(OH)q]include a polyhydric alcohol (such as an alcohol having from 1 to 15 carbons), such as 2,2-bis(hydroxymethyl)-1-butanol. Here, q is preferably from 1 to 6, and p is preferably from 1 to 30. In the case where q is two or more, p for each group in two or more pairs of parentheses (in the round brackets) may be the same or different. Examples of the above compound specifically include a 1,2-epoxy-4-(2-oxiranyl)cyclohexane adduct of 2,2-bis(hydroxymethyl)-1-butanol, trade name “EHPE3150” (available from Daicel Corporation).

Examples of the hydrogenated aromatic glycidyl ether-based epoxy compound include a compound (hydrogenated bisphenol A type epoxy compound) formed by hydrogenation of a bisphenol A type epoxy compound, such as 2,2-bis[4-(2,3-epoxypropoxy)cyclohexyl]propane, 2,2-bis[3,5-dimethyl-4-(2,3-epoxypropoxy)cyclohexyl]propane, and a multimer of these; a compound (hydrogenated bisphenol F type epoxy compound) formed by hydrogenation of a bisphenol F type epoxy compound, such as bis[o,o-(2,3-epoxypropoxy)cyclohexyl]methane, bis[o,p-(2,3-epoxypropoxy)cyclohexyl]methane, bis[p,p-(2,3-epoxypropoxy)cyclohexyl]methane, bis[3,5-dimethyl-4-(2,3-epoxypropoxy)cyclohexyl]methane, and a multimer of these; a hydrogenated biphenol type epoxy compound; a hydrogenated phenol novolac type epoxy compound; a hydrogenated cresol novolac type epoxy compound; a hydrogenated cresol novolac type epoxy compound of bisphenol A; a hydrogenated naphthalene type epoxy compound; and a hydrogenated epoxy compound of an epoxy compound obtained from trisphenol methane.

Examples of the aliphatic epoxy compound include a glycidyl ether of a q-hydric alcohol, the alcohol having no cyclic structure (q is a natural number); a glycidyl ester of a monovalent or polyvalent carboxylic acid (e.g., such as acetic acid, propionic acid, butyric acid, stearic acid, adipic acid, sebacic acid, maleic acid, and itaconic acid); an epoxidized product of an oil and/or fat having a double bond, such as an epoxidized linseed oil, an epoxidized soybean oil, and an epoxidized castor oil; and an epoxidized product of a polyolefin (including a polyalkadiene), such as an epoxidized polybutadiene.

Examples of the q-hydric alcohol having no cyclic structure include a monohydric alcohol, such as methanol, ethanol, 1-propyl alcohol, isopropyl alcohol, and 1-butanol; a dihydric alcohol, such as ethylene glycol, 1,2-propanediol, 1,3-propanediol, 1,4-butanediol, neopentyl glycol, 1,6-hexanediol, diethylene glycol, triethylene glycol, tetraethylene glycol, dipropylene glycol, polyethylene glycol, and polypropylene glycol; and a trihydric or higher polyhydric alcohol, such as glycerol, diglycerol, erythritol, trimethylolethane, trimethylolpropane, pentaerythritol, dipentaerythritol, and sorbitol. In addition, examples of the q-hydric alcohol include a polyether polyol, a polyester polyol, a polycarbonate polyol, and a polyolefin polyol.

Examples of the aromatic epoxy compound include an epibis type glycidyl ether type epoxy resin obtained by a condensation reaction of a bisphenol (e.g., such as bisphenol A, bisphenol F, bisphenol S, or fluorenebisphenol) and an epihalohydrin; a high molecular weight epibis type glycidyl ether type epoxy resin obtained by further subjecting the above epibis type glycidyl ether type epoxy resin to an addition reaction with the above bisphenol; a novolac alkyl type glycidyl ether type epoxy resin obtained by subjecting a phenol (e.g., such as phenol, cresol, xylenol, resorcin, catechol, bisphenol A, bisphenol F, or bisphenol S) and an aldehyde (e.g., such as formaldehyde, acetaldehyde, benzaldehyde, hydroxybenzaldehyde, or salicylaldehyde) to a condensation reaction to obtain a polyhydric alcohol, and then further subjecting the polyhydric alcohol to condensation reaction with epihalohydrin; and an epoxy compound in which two phenolic backbones are bonded to the 9-position of the fluorene ring, and glycidyl groups are each bonded directly or via an alkyleneoxy group to an oxygen atom, which is the remainder of a hydroxy group of these phenolic backbones with a hydrogen atom removed.

The content of the second epoxy compound in the curable composition of the present disclosure is preferably from 20 to 60 mass %, more preferably from 25 to 55 mass %, and even more preferably from 30 to 50 mass % per a total amount (100 mass %) of the curable compounds. The content within the above ranges enables the curable composition to be easily applied to a substrate.

### Polyorganosiloxane Having Silanol Group

The curable composition contains a polyorganosiloxane including a silanol group in addition to the first epoxy compound and the second epoxy compound. It is conceived that the silanol group contained in the polyorganosiloxane including a silanol group interacts with a substrate and a hard coat layer and improves the adhesion accordingly. In addition, the polyorganosiloxane including a silanol group is preferably a compound, which, specifically, has a different proportion of a silanol group from that of the first epoxy compound or a different number average molecular weight from that of the first epoxy compound and more preferably a compound, which has a different proportion of a silanol group from that of the first epoxy compound and a different number average molecular weight different from that of the first epoxy compound. One type of the polyorganosiloxanes including a silanol group may be used alone, or two or more types may be used.

The number average molecular weight (Mn) of the polyorganosiloxane including a silanol group determined by gel permeation chromatography and calibrated with standard polystyrene is not particularly limited but is, for example, preferably from 1000 to 20000, more preferably from 1500 to 15000, and even more preferably from 2000 to 10000.

Examples of the constituent unit contained in the polyorganosiloxane including a silanol group include a constituent unit (M unit) represented by [R₃SiO_{1/2}], a constituent unit (D unit) represented by [R₂SiO_{2/2}], a constituent unit (T unit) represented by [RSiO_{3/2}], and a constituent unit (Q unit) represented by [SiO_{4/2}]. Among others, the polyorganosiloxane including a silanol group preferably contains the T unit.

A ratio (total amount) of the T unit to a total amount (100 mol %) of the siloxane constituent units [all siloxane constituent units; the total amount of the M unit, the D unit, the T unit, and the Q unit] in the polyorganosiloxane including a silanol group is not particularly limited but is preferably 70 mol % or more, more preferably 80 mol % or more, and even more preferably 90 mol % or more. Adjusting the ratio to 70 mol % or more can facilitate improvement of the adhesion of the curable composition. The upper limit is not particularly limited but may be 100 mol % or more. The ratio of each siloxane constituent unit in the polyorganosilsesquioxane of the present disclosure can be calculated, for example, from the composition of the raw materials or by NMR spectroscopic measurements described later.

The proportion of a silanol group contained in the polyorganosiloxane including a silanol group is preferably 5% or more, more preferably 10% or more, even more preferably 15% or more, and particularly preferably 20% or more. The proportion of a silanol group of 5% or more makes it easier to exhibit adhesion to a substrate. In addition, the upper limit is not particularly limited but may be 50% or less.

The proportion of the silanol group can be measured by the following method.

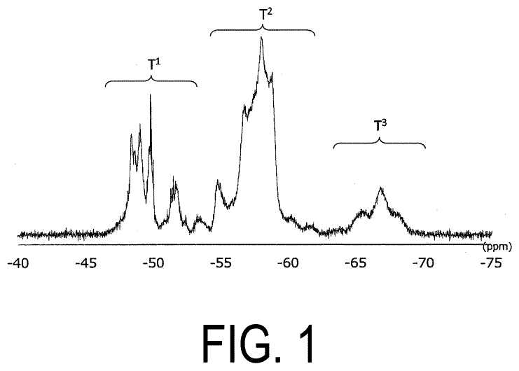

FIG. 1 shows a spectrum obtained by ²⁹Si-NMR measurement of an embodiment of the polyorganosiloxane including a silanol group. The waveform of the obtained spectrum is separated, and the peaks observed in chemical shifts of −47 ppm to −53 ppm are identified as those of a T1 form structure, the peaks observed from −54 ppm to −60 ppm are identified as those of a T2 form structure, and the peaks observed from −64 ppm to −70 ppm are identified as those of a T3 form structure. The T1 form, the T2 form, and the T3 form are each defined based on the number of silicon atoms bonded through an oxygen atom. At this time, a ratio (%) of each peak area value of the T1 to T3 forms to a total (100%) of each peak area value is a content ratio (mol %) of each structure (the T1 to T3 forms) in the polyorganosiloxane including a silanol group to be measured. Then, the proportion (%) of all silanol groups can be calculated according to the following equation using this value and the content ratio of hydroxy groups to the total number of moles of oxygen atoms and hydroxy groups in each structure of the T1 to T3 forms.

$$Proportion ( \% ) of silanol group = ( T 1 \times 2 / 3 + T 2 \times 1 / 3 + T 3 \times 0 / 3 )$$

In the above equation, T1, T2, and T3 each represent a ratio (%) of a peak area derived from each silicon atomic structure to a total (100%) of peak areas derived from silicon atomic structures obtained by ²⁹Si-NMR measurement, that is, a content ratio of each structure obtained from the above NMR measurement result.

In the same manner, the waveform of the spectrum obtained by ²⁹Si-NMR measurement is separated based on the D units, and the peaks are identified as those of the D1 form structure and those of the D2 form structure. The D1 form and the D2 form are each defined based on the number of silicon atoms bonded through an oxygen atom. In addition, the proportion (%) of all silanol groups can be calculated according to the following equation in the same manner as in the case of the T unit.

$$Proportion ( \% ) of silanol group = ( D 1 \times 1 / 2 + D 2 \times 0 / 2 )$$

In the same manner, the waveform of the spectrum obtained by ²⁹Si-NMR measurement is separated based on the Q units, and the peaks are identified as those of the Q1 form structure, those of the Q2 form structure, those of the Q3 form structure, and those of the Q4 form structure. The Q1 form, the Q2 form, the Q3 form, and the Q4 form are each defined based on the number of silicon atoms bonded through an oxygen atom. In addition, the proportion (%) of all silanol groups can be calculated according to the following equation in the same manner as in the case of the T unit.

$$Proportion ( \% ) of silanol group = ( Q 1 \times 3 / 4 + Q 2 \times 2 / 4 + Q 3 \times 1 / 4 + Q 4 \times 0 / 4 )$$

The proportion of a silanol group contained in the polyorganosiloxane including a silanol group can be calculated by measuring the proportion of a silanol group contained in the T unit, the D unit, and the Q unit described above and adding these together.

The ²⁹Si-NMR spectrum of the polyorganosiloxane including a silanol group can be measured, for example, with the following instrument and conditions.
Measuring instrument: trade name “JNM-ECA500 NMR” (available from JEOL Ltd.)
Solvent: deuterated chloroform
Number of scans: 10000
Measurement temperature: 25° C.

In addition, in the case where the polyorganosiloxane including a silanol group contains the T unit, the content of the T1 form is preferably 5% or more and more preferably 10% or more per a total (100%) of the T1 to T3 forms. The content of the T1 form of 5% or more can make it easier to provide a sufficient ratio of a silanol group. The upper limit is not particularly limited but may be 50% or less or 30% or less.

In addition, in the case where the polyorganosiloxane including a silanol group contains the T unit, the content of the T2 form is preferably 30% or more, more preferably 40% or more, and even more preferably 50% or more per a total (100%) of the T1 to T3 forms. The content of the T2 form of 30% or more can make it easier to provide a sufficient ratio of a silanol group. The upper limit is not particularly limited but may be 80% or less or 70% or less.

In addition, in the case where the polyorganosiloxane including a silanol group contains the T unit, the content of the T3 form is preferably 40% or less and more preferably 30% or less per a total (100%) of the T1 to T3 forms. The lower limit is not particularly limited but may be 5% or more or 10% or more.

The polyorganosiloxane including a silanol group preferably contains an active energy ray-curable functional group. Examples of the active energy ray-curable functional group include a photocationically polymerizable functional group and a photoradically polymerizable functional group, and the polyorganosiloxane including a silanol group preferably contains, among others, an epoxy group as the photocationically polymerizable functional group. In addition, examples of the epoxy group include the same epoxy groups as those exemplified as the epoxy groups contained in the first epoxy compound and the second epoxy compound, and in particular, the polyorganosiloxane including a silanol group preferably contains a glycidyl ether group or a group exemplified as an aromatic epoxy compound.

The content of the polyorganosiloxane including a silanol group is preferably from 1 to 15 mass % and more preferably from 2 to 10 mass % per a total amount (100 mass %) of the curable compounds. The content of the polyorganosiloxane including a silanol group of 1 mass % or more provides a sufficient amount of silanol groups and makes it easier to exhibit adhesion. In addition, the content of 15 mass % or less provides excellent storage stability.

### Oxetane Compound

In one embodiment of the curable composition of the present disclosure, the curable composition contains an oxetane compound in addition to the first epoxy compound, the second epoxy compound, and the polyorganosiloxane including a silanol group. The oxetane compound is a compound having, as a cationically polymerizable group, at least one or more oxetanyl groups per molecule and may be a compound having two or more oxetanyl groups per molecule. One type of the oxetane compounds can be used alone, or two or more types can be used. Containing the oxetane compound tends to enable the curable composition to exhibit adhesion to a substrate.

Examples of the oxetane compound include trimethylene oxide, 3,3-bis(vinyloxymethyl)oxetane, 3-ethyl-3-hydroxymethyl oxetane, 3-ethyl-3-(2-ethylhexyloxymethyl)oxetane, 3-ethyl-3-(hydroxymethyl)oxetane, 3-ethyl-3-[(phenoxy)methyl]oxetane, 3-ethyl-3-(hexyloxymethyl)oxetane, 3-ethyl-3-(chloromethyl)oxetane, 3,3-bis(chloromethyl)oxetane, 1,4-bis[(3-ethyl-3-oxetanylmethoxy)methyl]benzene, bis{[1-ethyl(3-oxetanyl)]methyl}ether, 4,4′-bis[(3-ethyl-3-oxetanyl)methoxymethyl]bicyclohexyl, 1,4-bis[(3-ethyl-3-oxetanyl)methoxymethyl]cyclohexane, and 3-{ethyl-[ethyl(3-ethyloxetan-3-yl)methoxy]methyl}oxetane.

The content of the oxetane compound is preferably from 5 to 25 mass % and more preferably from 10 to 20 mass % per a total amount (100 mass %) of the curable compounds. The content of the oxetane compound within the above ranges makes it easier to exhibit adhesion to a substrate.

The curable composition may contain a third epoxy compound and a fourth epoxy compound described below together with the oxetane compound.

### Third Epoxy Compound

In addition, in another embodiment of the curable composition of the present disclosure, the curable composition preferably contains a third epoxy compound in addition to the first epoxy compound, the second epoxy compound, and the polyorganosiloxane including a silanol group. This third epoxy compound does not correspond to the first epoxy compound and the polyorganosiloxane including a silanol group and is a component different from the second epoxy compound. In the curable composition, an epoxy compound contained in larger amount is the second epoxy compound, and an epoxy compound contained in smaller amount is the third epoxy compound.

Examples of the third epoxy compound include an epoxy compound other than the epoxy compound used as the second epoxy compound among epoxy compounds that do not correspond to the first epoxy compound and the polyorganosiloxane including a silanol group. Specifically, an epoxy compound exemplified as the second epoxy compound described above can be used as the third epoxy compound.

Particularly in the case where the curable composition contains an alicyclic epoxy compound as the second epoxy compound, the curable composition preferably contains an aliphatic epoxy compound as the third epoxy compound. Containing the aliphatic epoxy compound as the third epoxy compound makes it easier to exhibit adhesion to a substrate. For the aliphatic epoxy compound, an aliphatic epoxy compound exemplified as the aliphatic epoxy compound of the second epoxy compound can be used.

In the case where the curable composition contains the third epoxy compound, the content of the third epoxy compound is preferably from 5 to 25 mass % and more preferably from 7 to 20 mass % per a total amount (100 mass %) of the curable compounds. The content of the third epoxy compound within the above ranges makes it easier to exhibit adhesion to a substrate.

In addition, the curable composition may further contain an epoxy compound (hereinafter referred to as “the fourth epoxy compound”) besides the first to third epoxy compounds and the polyorganosiloxane including a silanol group. For the fourth epoxy compound, among epoxy compounds that do not correspond to the first epoxy compound, an epoxy compound other than those used as the second or third epoxy compound can be used. That is, for the fourth epoxy compound, among the epoxy compounds exemplified as the second epoxy compound described above, an epoxy compound other than those used as the second or third epoxy compound can be used. In the curable composition, the fourth epoxy compound is an epoxy compound included in smaller amount than the second epoxy compound and the third epoxy compound. For the fourth epoxy compound, one type can be used alone, or two or more types can be used.

In addition, in the case where the curable composition is a thermosetting composition, the curable composition may further contain a thermosetting resin. Examples of the thermosetting resin include a phenolic resin, a melamine resin, a urea resin, a silicone resin, an epoxy resin, an unsaturated polyester, a vinyl ester resin, and a polyurethane. For the thermosetting resins, one type can be used alone, or two or more types can be used.

The curable composition preferably further contains a curing agent. For the curing agent, a known or commonly used thermal polymerization initiator or photopolymerization initiator can be used, a photopolymerization initiator is preferably used, and among others, a photocationic polymerization initiator can be preferably used as the photopolymerization initiator. One type of the curing agents can be used alone, or two or more types can be used.

For the photocationic polymerization initiator, a known or commonly used photocationic polymerization initiator can be used, and examples include a sulfonium salt (a salt of a sulfonium ion and an anion), an iodonium salt (a salt of an iodonium ion and an anion), a selenium salt (a salt of a selenium ion and an anion), an ammonium salt (a salt of an ammonium ion and an anion), a phosphonium salt (a salt of a phosphonium ion and an anion), and a salt of a transition metal complex ion and an anion.

Examples of the sulfonium salt include a triarylsulfonium salt, such as a triphenylsulfonium salt, a tri-p-tolylsulfonium salt, a tri-o-tolylsulfonium salt, a tris(4-methoxyphenyl)sulfonium salt, a 1-naphthyldiphenylsulfonium salt, a 2-naphthyldiphenylsulfonium salt, a tris(4-fluorophenyl)sulfonium salt, a tri-1-naphthylsulfonium salt, a tri-2-naphthyldiphenylsulfonium salt, a tris(4-hydroxyphenyl)sulfonium salt, a diphenyl[4-(phenylthio)phenyl]sulfonium salt, a 4-(p-tolylthio)phenyldi-(p-phenyl)sulfonium salt; a diarylsulfonium salt, such as a diphenylphenacylsulfonium salt, a diphenyl 4-nitrophenacylsulfonium salt, a diphenylbenzylsulfonium salt, and a diphenylmethylsulfonium salt; a monoarylsulfonium salt, such as a phenylmethylbenzylsulfonium salt, a 4-hydroxyphenylmethylbenzylsulfonium salt, and a 4-methoxyphenylmethylbenzyl sulfonium salt; and a trialkyl sulfonium salt, such as a dimethylphenacyl sulfonium salt, a phenacyl tetrahydrothiophenium salt, and a dimethyl benzylsulfonium salt.

Examples of the diphenyl[4-(phenylthio)phenyl]sulfonium salt include diphenyl[4-(phenylthio)phenyl]sulfonium tetrakis(pentafluorophenyl)borate and diphenyl[4-(phenylthio)phenyl]sulfonium hexafluorophoshate. In addition, a commercial product, such as trade name “CPI-100P” (diphenyl[4-(phenylthio)phenyl]sulfonium hexafluorophosphate 50% propylene carbonate solution, available from San-Apro Ltd.), can also be used.

Examples of the iodonium salt include trade name “RHODORSIL PHOTOINITIATOR 2074” (tetrakis(pentafluorophenyl)borate[(1-methylethyl)phenyl](methylphenyl)iodonium, available from Rhodia Japan Ltd.), trade name “WPI-124” (available from Wako Pure Chemical Industries, Ltd.), a diphenyliodonium salt, a di-p-tolyliodonium salt, a bis(4-dodecylphenyl)iodonium salt, and a bis(4-methoxyphenyl)iodonium salt.

Examples of the selenium salt include a triarylselenium salt, such as a triphenylselenium salt, a tri-p-tolylselenium salt, a tri-o-tolylselenium salt, a tris(4-methoxyphenyl)selenium salt, and a 1-naphthyldiphenylselenium salt; a diarylselenium salt, such as a diphenylphenacylselenium salt, a diphenylbenzylselenium salt, and a diphenylmethylselenium salt; a monoarylselenium salt, such as a phenylmethylbenzylselenium salt; and a trialkylselenium salt, such as a dimethylphenacylselenium salt.

Examples of the ammonium salt include a tetraalkyl ammonium salt, such as a tetramethyl ammonium salt, an ethyltrimethyl ammonium salt, a diethyldimethyl ammonium salt, a triethylmethyl ammonium salt, a tetraethyl ammonium salt, a trimethyl-n-propyl ammonium salt, and a trimethyl-n-butyl ammonium salt; a pyrrolidium salt, such as an N,N-dimethylpyrrolidium salt and an N-ethyl-N-methylpyrrolidium salt; an imidazolinium salt, such as an N,N′-dimethylimidazolinium salt and an N,N′-diethylimidazolinium salt; a tetrahydropyrimidium salt, such as an N,N′-dimethyltetrahydropyrimidium salt and an N,N′-diethyltetrahydropyrimidium salt; a morpholinium salt, such as an N,N-dimethylmorpholinium salt and an N,N-diethylmorpholinium salt; a piperidinium salt, such as an N,N-dimethylpiperidinium salt and an N,N-diethylpiperidinium salt; a pyridinium salt, such as an N-methylpyridinium salt and an N-ethylpyridinium salt; an imidazolium salt, such as an N,N′-dimethylimidazolium salt; a quinolium salt, such as an N-methylquinolium salt; an isoquinolium salt, such as an N-methylisoquinolium salt; a thiazonium salt, such as a benzylbenzothiazonium salt; and an acrydium salt, such as a benzylacrydium salt.

Examples of the phosphonium salt include a tetraarylphosphonium salt, such as a tetraphenylphosphonium salt, a tetra-p-tolylphosphonium salt, and a tetrakis(2-methoxyphenyl)phosphonium salt; a triarylphosphonium salt, such as a triphenylbenzylphosphonium salt; and a tetraalkylphosphonium salt, such as a triethylbenzylphosphonium salt, a tributylbenzylphosphonium salt, a tetraethylphosphonium salt, a tetrabutylphosphonium salt, and a triethylphenacylphosphonium salt.

Examples of the salt of a transition metal complex ion include a salt of a chromium complex cation, such as (η⁵-cyclopentadienyl)(η⁶-toluene)Cr⁺ and (η⁵-cyclopentadienyl)(η⁶-xylene)Cr⁺; and a salt of an iron complex cation, such as (η⁵-cyclopentadienyl)(η⁶-toluene)Fe⁺ and (η⁵-cyclopentadienyl)(η⁶-xylene)Fe⁺.

Examples of the anion constituting the above salt include PF₆⁻, BF₄⁻, (C₆F₅)₄B⁻, (C₆F₅)₄Ga⁻, a sulfonate anion, a perhalate ion, a halogenated sulfonate ion, a sulfate ion, a carbonate ion, an aluminate ion, a carboxylate ion, an arylborate ion, a thiocyanate ion, and a nitrate ion.

The amount of the curing agent to be used (blended amount) is preferably from 0.01 to 15 parts by mass, more preferably from 0.03 to 10 parts by mass, even more preferably from 0.05 to 10 parts by mass, and particularly preferably from 0.1 to parts by mass per a total amount (100 parts by mass) of the curable compounds contained in the curable composition. Using the curing agent within the above ranges can provide a cured product having excellent adhesion to a substrate.

The curable composition preferably further contains an antioxidant. For the antioxidant, a known or commonly used antioxidant can be used. One type of the antioxidants can be used alone, or two or more types can be used.

For the antioxidant, a known or commonly used antioxidant can be used and is not particularly limited. However, examples include a phenol-based antioxidant (phenol-based compound), a hindered amine-based antioxidant (hindered amine-based compound), a phosphorous-based antioxidant (phosphorous-based compound), and a sulfur-based antioxidant (sulfur-based compound).

Examples of the phenol-based antioxidant include monophenols, such as 2,6-di-t-butyl-p-cresol, butylated hydroxyanisole, 2,6-di-t-butyl-p-ethylphenol, and stearyl-p-(3,5-di-t-butyl-4-hydroxyphenyl)propionate; bisphenols, such as 2,2′-methylenebis(4-methyl-6-t-butylphenol), 2,2′-methylenebis(4-ethyl-6-t-butylphenol), 4,4′-thiobis(3-methyl-6-t-butylphenol), 4,4′-butylidenebis(3-methyl-6-t-butylphenol), and 3,9-bis[1,1-dimethyl-2-{f-(3-t-butyl-4-hydroxy-5-methylphenyl)propionyloxy}ethyl]2,4,8,10-tetraoxaspiro[5.5]undecane; and polymeric phenols, such as 1,1,3-tris(2-methyl-4-hydroxy-5-t-butylphenyl)butane, 1,3,5-trimethyl-2,4,6-tris(3,5-di-t-butyl-4-hydroxybenzyl)benzene, tetrakis[methylene-3-(3′,5′-di-t-butyl-4′-hydroxyphenyl)propionate]methane, bis[3,3′-bis(4′-hydroxy-3′-t-butylphenyl)butyric acid]glycol ester, 1,3,5-tris(3′,5′-di-t-butyl-4′-hydroxybenzyl)-s-triazine-2,4,6-(1H,3H,5H)trione, and tocophenol.

Examples of the hindered amine-based antioxidant include bis(1,2,2,6,6-pentamethyl-4-piperidyl)[[3,5-bis(1,1-dimethylethyl)-4-hydroxyphenyl]methyl]butyl malonate, bis(1,2,2,6,6-pentamethyl-4-piperidyl)sebacate, methyl-1,2,2,6,6-pentamethyl-4-piperidyl sebacate, and 4-benzoyloxy-2,2,6,6-tetramethylpiperidine.

Examples of the phosphorus-based antioxidant include phosphites such as triphenyl phosphite, diphenylisodecyl phosphite, phenyldiisodecyl phosphite, tris(nonylphenyl)phosphite, diisodecyl pentaerythritol phosphite, tris(2,4-di-t-butylphenyl)phosphite, cyclic neopentanetetraylbis(octadecyl)phosphite, cyclic neopentanetetraylbis(2,4-di-t-butylphenyl)phosphite, cyclic neopentanetetraylbis(2,4-di-t-butyl-4-methylphenyl)phosphite, and bis[2-t-butyl-6-methyl-4-{2-(octadecyloxycarbonyl)ethyl}phenyl]hydrogen phosphite; and an oxaphosphaphenanthrene oxide, such as 9,10-dihydro-9-oxa-10-phosphaphenanthrene-10-oxide and 10-(3,5-di-t-butyl-4-hydroxybenzyl)-9,10-dihydro-9-oxa-10-phosphaphenanthrene-10-oxide.

Examples of the sulfur-based antioxidant include dodecanethiol, dilauryl-3,3′-thiodipropionate, dimyristyl-3,3′-thiodipropionate, and distearyl-3,3′-thiodipropionate.

Among these, the antioxidant is preferably a phenol-based antioxidant, a phosphorus-based antioxidant, or a sulfur-based antioxidant, and particularly preferably a phenol-based antioxidant.

The amount of the antioxidant to be used (blended amount) is preferably from 0.01 to 15 parts by mass, more preferably from 0.03 to 10 parts by mass, even more preferably from 0.05 to 10 parts by mass, and particularly preferably from 0.1 to 5 parts by mass per a total amount (100 parts by mass) of the curable compounds.

### Additional Compound

The curable composition of the present disclosure may contain an additional compound in addition to the above compounds. Examples of the additional compound include a solvent, a metal oxide particle, a rubber particle, a silicone-based antifoaming agent, a silane coupling agent, a filler, a plasticizer, an antistatic agent, a flame retardant, a colorant, an ultraviolet absorber, an ion adsorbent, a pigment and a release agent. The content (blended amount) of these various additives is preferably 5 mass % or less of the total amount (100 mass %) of the curable composition.

In addition, the curable composition preferably contains no compound corresponding to a PFAS. Having the above configuration eliminates the use of a compound corresponding to a PFAS and enables the curable composition to be compliant with environmental regulations and to have excellent safety. In the present disclosure, “a compound corresponding to a PFAS” is a generic term for a perfluoroalkyl substance and a polyfluoroalkyl substance.

In addition, the content of a deleterious substance in the curable composition is preferably 1000 mass ppm or less and more preferably 0 mass ppm per a total amount (100 mass %) of the curable composition. That is, the curable composition preferably contains no deleterious substance. Specific examples of the deleterious substance include an antimony compound.

### Undercoat Layer

An embodiment according to the present disclosure includes an undercoat layer containing a cured product of the curable composition. The undercoat layer can be obtained, for example, by applying the curable composition to at least one surface of a substrate and curing the composition.

The substrate may be a single-layer substrate or a multiple-layer substrate composed of the same or different materials. In addition, for the substrate, a resin substrate, a glass substrate, a metal substrate, or the like can be used, and a glass substrate is preferred from the viewpoint of adhesion to the undercoat layer.

For a method of forming the undercoat layer, a common coating method can be used. For example, a known method can be used, such as a dipping method, roll coating, gravure coating, reverse coating, air knife coating, comma coating, die coating, a screen printing method, spray coating, inkjet coating, spin coating, a gravure offset method, or an organic vapor deposition method. In the case where the curable composition is a photocurable composition, examples of the curing treatment include light irradiation using a mercury lamp, a xenon lamp, a carbon arc lamp, a metal halide lamp, sunlight, an electron beam source, a laser beam source, an LED light source, or the like. The photocurable composition is preferably irradiated in a range in which the cumulative irradiation dose is, for example, from 300 to 10000 mJ/cm². In the case where the curable composition is a thermosetting composition, the composition may be treated under the conditions of a heating temperature of 50 to 200° C. and a heating time of 5 to 120 minutes. In addition, the heating temperature may be constant or may be changed stepwise. Furthermore, a film applied to coat another substrate in advance by the above forming method may be transferred to the substrate using a transfer method, such as adhesive transfer, thermal transfer, or UV transfer.

In the case where the curable composition is a photocurable composition, the composition is preferably annealed to remove an internal strain after completion of the light irradiation. For example, the composition is preferably heated at a temperature of 100 to 200° C. for about 30 minutes to 1 hour.

In addition, the curable composition can preferably be applied to a substrate without cissing when the appearance of the undercoat layer is visually observed after curing. The curable composition can more preferably be applied uniformly without roughness on the undercoat layer surface.

The thickness of the undercoat layer is preferably from 0.1 to 20 μm and more preferably from 1 to 15 μm. The thickness of the undercoat layer of 0.1 μm or more can make it easier to exhibit adhesion to a substrate and a hard coat layer. In addition, the thickness of 20 μm or less makes it easier to improve the surface hardness of a hard coat layer surface when a hard coat layer is laminated.

### Laminate

An embodiment according to the present disclosure includes a laminate including the substrate, the undercoat layer, and a hard coat layer. The laminate can be produced by further forming a hard coat layer on the undercoat layer formed on the substrate. In the laminate, the laminated structure may be formed on only one surface (one side) of the substrate or may be formed on both surfaces (both sides). In addition, the laminate may have a layer besides the undercoat layer and the hard coat layer, and from the viewpoint of exhibiting adhesion of the laminate, the substrate, the undercoat layer, and the hard coat layer are preferably laminated in this order.

The hard coat layer preferably contains a curing-type resin and preferably contains, as the curing-type resin, a curing-type polyorganosilsesquioxane resin that is a cured product of a polyorganosilsesquioxane having a constituent unit represented by Formula (1) below (which may be hereinafter referred to as “the polyorganosilsesquioxane of the present disclosure”). In other words, the curable composition for forming the hard coat layer (which may be hereinafter referred to as “the hard coating agent”) preferably contains a polyorganosilsesquioxane having a constituent unit represented by Formula (1) below. As described later, the hard coating agent may contain an additional component, such as a curing agent (in particular, a photocationic polymerization initiator or a photoradical polymerization initiator) or an antioxidant.

[Chem. 3]

[R¹SiO_{3/2}] (1)

In Formula (1), R¹ represents a group containing an active energy ray-curable functional group.

The polyorganosilsesquioxane of the present disclosure is characterized by having a constituent unit represented by Formula (1) above. In addition, the polyorganosilsesquioxane of the present disclosure preferably has a constituent unit (which may be referred to as “the T3 form”) represented by Formula (I) below and a constituent unit (which may be referred to as “the T2 form”) represented by Formula (II) below. Furthermore, the polyorganosilsesquioxane of the present disclosure preferably has a constituent unit represented by Formula (4) described later.

[Chem. 4]

[R^{a}SiO_{3/2}] (I)

[Chem. 5]

[R^{b}SiO_{2/2}(OR^{c})] (II)

The constituent unit represented by Formula (1) above is a silsesquioxane constituent unit (T unit) generally represented by [RSiO_{3/2}]. R in the formula above represents a hydrogen atom or a monovalent organic group, and the same applies to the following. The constituent unit represented by Formula (1) above is formed by a hydrolysis and condensation reaction of a corresponding hydrolyzable trifunctional silane compound (specifically, e.g., a compound represented by Formula (a) described later).

R¹ in Formula (1) represents a group (monovalent group) containing an active energy ray-curable functional group. That is, the polyorganosilsesquioxane of the present disclosure is a photocationically curable compound (photocationically polymerizable compound) or a photoradically curable compound (photoradically polymerizable compound), the curable compound having at least an active energy ray-curable functional group in the molecule.

The “photocationically polymerizable functional group” in the group containing an active energy ray-curable functional group is not particularly limited as long as it is photocationically polymerizable, and examples include an epoxy group, an oxetane group, a vinyl ether group, and a vinylphenyl group. The “photoradically polymerizable functional group” in the group containing an active energy ray-curable functional group is not particularly limited as long as it is photoradically polymerizable, and examples include a (meth)acryloxy group, a (meth)acrylamide group, a vinyl group, and a vinylthio group. From the viewpoint of surface hardness of the cured product (coating film), the active energy ray-curable functional group is preferably an epoxy group, a (meth)acryloxy group, or the like, and is particularly preferably an epoxy group.

Examples of the group containing an epoxy group include a known or commonly used group having an oxirane ring and are not particularly limited. However, in terms of the curability of the hard coating agent, the scratch resistance and toughness of the cured product (coating film), the group is preferably a group represented by Formula (1a) below, a group represented by Formula (1b) below, a group represented by Formula (1c) below, or a group represented by Formula (1d) below, more preferably a group represented by Formula (1a) below or a group represented by Formula (1c) below, and even more preferably a group represented by Formula (1a) below.

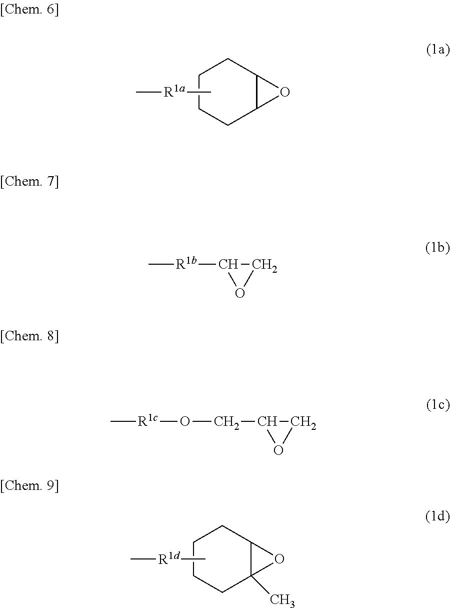

In Formula (1a) above, R^{1a} represents a linear or branched alkylene group. Examples of the linear or branched alkylene group include a linear or branched alkylene group having from 1 to 10 carbons, such as a methylene group, a methylmethylene group, a dimethylmethylene group, an ethylene group, a propylene group, a trimethylene group, a tetramethylene group, a pentamethylene group, a hexamethylene group, and a decamethylene group. Among these, in terms of the scratch resistance and toughness of the cured product (coating film), R^{1a} is preferably a linear alkylene group having from 1 to 4 carbons or a branched alkylene group having 3 or 4 carbons, more preferably an ethylene group, a trimethylene group, or a propylene group, and even more preferably an ethylene group or a trimethylene group.

In Formula (1b) above, R^{1b} represents a linear or branched alkylene group and exemplified by the same group as those of Ria. Among these, in terms of the scratch resistance and toughness of the cured product (coating film), R^{1b} is preferably a linear alkylene group having from 1 to 4 carbons or a branched alkylene group having 3 or 4 carbons, more preferably an ethylene group, a trimethylene group, or a propylene group, and even more preferably an ethylene group or a trimethylene group.

In Formula (1c) above, R^{1c} represents a linear or branched alkylene group and exemplified by the same group as those of R^{1a}. Among these, in terms of the scratch resistance and toughness of the cured product (coating film), R^{1c} is preferably a linear alkylene group having from 1 to 4 carbons or a branched alkylene group having 3 or 4 carbons, more preferably an ethylene group, a trimethylene group, or a propylene group, and even more preferably an ethylene group or a trimethylene group.

In Formula (1d) above, R^{1d} represents a linear or branched alkylene group and exemplified by the same group as those of R^{1a}. Among these, in terms of the scratch resistance and toughness of the cured product (coating film), R^{1d} is preferably a linear alkylene group having from 1 to 4 carbons or a branched alkylene group having 3 or 4 carbons, more preferably an ethylene group, a trimethylene group, or a propylene group, and even more preferably an ethylene group or a trimethylene group.

In terms of the scratch resistance and toughness of the cured product (coating film), R¹ in Formula (1) is particularly preferably a group represented by Formula (1a) above where R^{1a} is an ethylene group [among others, a 2-(3′,4′-epoxycyclohexyl)ethyl group].

Examples of the group containing an oxetane group include a known or commonly used group having an oxetane ring and are not particularly limited. However, examples include an oxetane group itself and a group obtained by substituting a hydrogen atom (usually one or more and preferably one hydrogen atom) of an alkyl group (alkyl group having preferably from 1 to 10 carbons and more preferably from 1 to 5 carbons) with an oxetane group. In terms of the curability of the hard coating agent, the scratch resistance and toughness of the cured product (coating film), the group is preferably a 3-oxetanyl group, an oxetan-3-ylmethyl group, a 3-ethyloxetan-3-ylmethyl group, a 2-(oxetan-3-yl)ethyl group, a 2-(3-ethyloxetan-3-yl)ethyl group, a 3-(oxetan-3-ylmethoxy)propyl group, a 3-(3-ethyloxetan-3-ylmethoxy)propyl group, or the like.

Examples of the group containing a vinyl ether group include a known or commonly used group having a vinyl ether group and are not particularly limited. However, examples include a vinyl ether group itself and a group obtained by substituting a hydrogen atom (usually one or more and preferably one hydrogen atom) of an alkyl group (alkyl group having preferably from 1 to 10 carbons and more preferably from 1 to 5 carbons) with a vinyl ether group. In terms of the curability of the hard coating agent, the scratch resistance and toughness of the cured product (coating film), the group is preferably a vinyloxymethyl group, a 2-(vinyloxy)ethyl group, a 3-(vinyloxy)propyl group, or the like.

Examples of the group containing a vinylphenyl group include a known or commonly used group having a vinylphenyl group and are not particularly limited. However, examples include a vinylphenyl group itself and a group obtained by substituting a hydrogen atom (usually one or more and preferably one hydrogen atom) of an alkyl group (alkyl group having preferably from 1 to 10 carbons and more preferably from 1 to 5 carbons) with a vinylphenyl group. In terms of the curability of the hard coating agent, the scratch resistance and toughness of the cured product (coating film), the group is preferably a 4-vinylphenyl group, a 3-vinylphenyl group, a 2-vinylphenyl group, or the like.

Examples of the group containing a (meth)acryloxy group include a known or commonly used group having a (meth)acryloxy group and are not particularly limited. However, examples include a (meth)acryloxy group itself and a group obtained by substituting a hydrogen atom (usually one or more and preferably one hydrogen atom) of an alkyl group (alkyl group having preferably from 1 to 10 carbons and more preferably from 1 to 5 carbons) with a (meth)acryloxy group. In terms of the curability of the hard coating agent (coating film), the scratch resistance and toughness of the cured product (coating film), the group is preferably a 2-((meth)acryloxy)ethyl group, a 3-((meth)acryloxy)propyl group, or the like.

Examples of the group containing a (meth)acrylamide group include a known or commonly used group having a (meth)acrylamide group and are not particularly limited. However, examples include a (meth)acrylamide group itself and a group obtained by substituting a hydrogen atom (usually one or more and preferably one hydrogen atom) of an alkyl group (alkyl group having preferably from 1 to 10 carbons and more preferably from 1 to 5 carbons) with a (meth)acrylamide group. In terms of the curability of the hard coating agent, the scratch resistance and toughness of the cured product (coating film), the group is preferably a 2-((meth)acrylamide)ethyl group, a 3-((meth)acrylamide)propyl group, or the like.

Examples of the group containing a vinyl group include a known or commonly used group having a vinyl group and are not particularly limited. However, examples include a vinyl group itself and a group obtained by substituting a hydrogen atom (usually one or more and preferably one hydrogen atom) of an alkyl group (alkyl group having preferably from 1 to 10 carbons and more preferably from 1 to 5 carbons) with a vinyl group. In terms of the curability of the hard coating agent, the scratch resistance and toughness of the cured product (coating film), the group is preferably a vinyl group, a vinylmethyl group, a 2-vinylethyl group, a 3-vinylpropyl group, or the like.

Examples of the group containing a vinylthio group include a known or commonly used group having a vinylthio group and are not particularly limited. However, examples include a vinylthio group itself and a group obtained by substituting a hydrogen atom (usually one or more and preferably one hydrogen atom) of an alkyl group (alkyl group having preferably from 1 to 10 carbons and more preferably from 1 to 5 carbons) with a vinylthio group. In terms of the curability of the hard coating agent, the scratch resistance and toughness of the cured product (coating film), the group is preferably a vinylthiomethyl group, a 2-(vinylthio)ethyl group, a 3-(vinylthio)propyl group, or the like.

In terms of the scratch resistance and toughness of the cured product (coating film), R¹ in Formula (1) is preferably a group containing an epoxy group or a group containing a (meth)acryloxy group, and is particularly preferably a group represented by Formula (1a) above where R^{1a} is an ethylene group [among others, a 2-(3′,4′-epoxycyclohexyl)ethyl group], a 3-(acryloxy)propyl group, or a 3-(methacryloxy)propyl group.

The polyorganosilsesquioxane of the present disclosure may have only one type of constituent unit represented by Formula (1) above or may have two or more types of constituent units represented by Formula (1) above.

The polyorganosilsesquioxane of the present disclosure may also have, as the silsesquioxane constituent unit [RSiO_{3/2}], a constituent unit represented by Formula (2) below in addition to the constituent unit represented by Formula (1) above.

[Chem. 10]

[R²SiO_{3/2}] (2)

The constituent unit represented by Formula (2) above is a silsesquioxane constituent unit (T unit) generally represented by [RSiO_{3/2}]. That is, the constituent unit represented by Formula (2) above is formed by a hydrolysis and condensation reaction of a corresponding hydrolyzable trifunctional silane compound (specifically, e.g., a compound represented by Formula (b) described later).

R² in Formula (2) above represents a substituted or unsubstituted aryl group, a substituted or unsubstituted aralkyl group, a substituted or unsubstituted cycloalkyl group, a substituted or unsubstituted alkyl group, or a substituted or unsubstituted alkenyl group. Examples of the aryl group include a phenyl group, a tolyl group, and a naphthyl group. Examples of the aralkyl group include a benzyl group and a phenethyl group. Examples of the cycloalkyl group include a cyclobutyl group, a cyclopentyl group, and a cyclohexyl group. Examples of the alkyl group include a linear or branched alkyl group, such as a methyl group, an ethyl group, a propyl group, an n-butyl group, an isopropyl group, an isobutyl group, an s-butyl group, a t-butyl group, and an isopentyl group. Examples of the alkenyl group include a linear or branched alkenyl group, such as a vinyl group, an allyl group, and an isopropenyl group.

Examples of the substituted aryl group, the substituted aralkyl group, the substituted cycloalkyl group, the substituted alkyl group, and the substituted alkenyl group described above include a group in which one, some, or all of hydrogen atoms or part or the whole of the main chain backbone in each of the aryl group, the aralkyl group, the cycloalkyl group, the alkyl group, and the alkenyl group described above are substituted with at least one type selected from the group consisting of an ether group, an ester group, a carbonyl group, a siloxane group, a halogen atom (such as a fluorine atom), an acryl group, a methacryl group, a mercapto group, an amino group, and a hydroxy group.

Among these, R² is preferably a substituted or unsubstituted aryl group, a substituted or unsubstituted alkyl group, or a substituted or unsubstituted alkenyl group, more preferably a substituted or unsubstituted aryl group, and even more preferably a phenyl group.

A ratio of each silsesquioxane constituent unit described above (the constituent unit represented by Formula (1) and the constituent unit represented by Formula (2)) in the polyorganosilsesquioxane of the present disclosure can be appropriately adjusted by composition of the raw materials (hydrolyzable trifunctional silanes) for forming these constituent units.

The polyorganosilsesquioxane of the present disclosure may further have at least one type of siloxane constituent unit selected from the group consisting of a silsesquioxane constituent unit [RSiO_{3/2}] other than the constituent unit represented by Formula (1) above and the constituent unit represented by Formula (2) above, the M unit, the D unit, and Q unit. Examples of the silsesquioxane constituent unit other than the constituent unit represented by Formula (1) above and the constituent unit represented by Formula (2) above include a constituent unit represented by Formula (3) below.

[Chem. 11]

[HSiO_{3/2}] (3)

In the case where the polyorganosilsesquioxane of the present disclosure has the constituent unit (T3 form) represented by Formula (I) above and the constituent unit (T2 form) represented by Formula (II) above, the ratio [T3 form/T2 form] is not particularly limited but, for example, can be appropriately selected from a range of 5 or more (e.g., 5 or more and 500 or less). The lower limit value of the ratio [T3 form/T2 form] is preferably 20, more preferably 21, even more preferably 23, and still more preferably 25. Adjusting the ratio [T3 form/T2 form] to 5 or more tends to improve the surface hardness, scratch resistance, and toughness of the cured product (coating film). On the other hand, the upper limit value of the ratio [T3 form/T2 form] is preferably 500, more preferably 100, even more preferably 50, and still more preferably 40. Adjusting the ratio [T3 form/T2 form] to 500 or less improves the miscibility with other components in the hard coating agent and also reduces viscosity, thus facilitating handling and application as a hard coating agent.

The constituent unit represented by Formula (I) above is represented by Formula (I′) below in more detail. In addition, the constituent unit represented by Formula (II) above is represented by Formula (II′) below in more detail. Three oxygen atoms bonded to the silicon atom shown in the structure represented by Formula (I′) below are each bonded to another silicon atom (a silicon atom not shown in Formula (I′)). On the other hand, two oxygen atoms located above and below the silicon atom shown in the structure represented by Formula (II′) below are each bonded to another silicon atom (a silicon atom not shown in Formula (II′)). That is, both the T3 form and the T2 form are constituent units (T units) formed by a hydrolysis and condensation reaction of a corresponding hydrolyzable trifunctional silane compound.

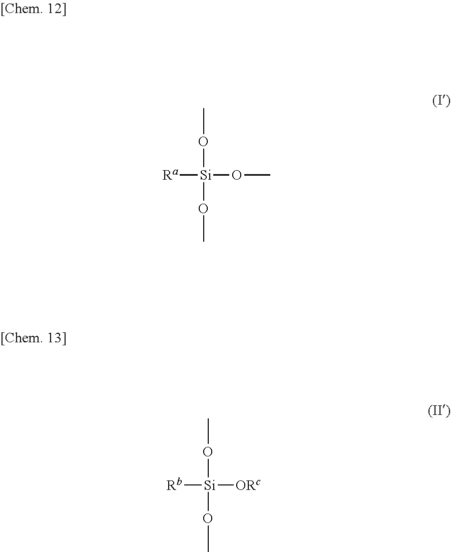

R^{a} in Formula (I) above (likewise, R^{a} in Formula (I′)) and R^{b} in Formula (II) above (likewise, R^{b} in Formula (II′)) each represent a group containing an active energy ray-curable functional group, a substituted or unsubstituted aryl group, a substituted or unsubstituted aralkyl group, a substituted or unsubstituted cycloalkyl group, a substituted or unsubstituted alkyl group, a substituted or unsubstituted alkenyl group, or a hydrogen atom. Specific examples of R^{a} and R^{b} include the same examples as those given for R¹ in Formula (1) above and R² in Formula (2) above. R^{a} in Formula (I) and R^{b} in Formula (II) are each derived from a group (a group other than an alkoxy group and a halogen atom; e.g., R¹, R², a hydrogen atom, and the like in Formulas (a) to (c) described later) bonded to a silicon atom in the hydrolyzable trifunctional silane compound used as a raw material for the polyorganosilsesquioxane of the present disclosure.

R^{c} in Formula (II) above (likewise, R^{c} in Formula (II′)) represents a hydrogen atom or an alkyl group having from 1 to 4 carbons. Examples of the alkyl group having from 1 to 4 carbons include a linear or branched alkyl group having from 1 to 4 carbons, such as a methyl group, an ethyl group, a propyl group, an isopropyl group, a butyl group, and an isobutyl group. The alkyl group in R^{c} in Formula (II) is usually derived from an alkyl group that forms an alkoxy group (e.g., such as an alkoxy group as X¹ to X³ described later) in the hydrolyzable silane compound used as a raw material for the polyorganosilsesquioxane of the present disclosure.

The ratio [T3 form/T2 form] in the polyorganosilsesquioxane of the present disclosure can be determined, for example, by ²⁹Si-NMR spectroscopic measurements. In the ²⁹Si-NMR spectrum, the silicon atom in the constituent unit represented by Formula (I) above (T3 unit) and the silicon atom in the constituent unit represented by Formula (II) above (T2 unit) exhibit signals (peaks) at different positions (chemical shifts). Thus, the ratio [T3 unit/T2 unit] can be determined by calculating the integration ratio of each of these peaks. Specifically, for example, in the case where the polyorganosilsesquioxane of the present disclosure has a constituent unit represented by Formula (1) above where R¹ is a 2-(3′,4′-epoxycyclohexyl)ethyl group, the signal of the silicon atom in the structure represented by Formula (I) above (T3 form) appears at −62 to −72 ppm, and the signal of the silicon atom in the structure represented by Formula (II) above (T2 form) appears at −55 to −60 ppm. Thus, in this case, the ratio [T3 form/T2 form] can be determined by calculating the integration ratio of the signal at −62 to −72 ppm (T3 form) and the signal at −55 to −60 ppm (T2 form). Also in the case where R¹ is a group containing an active energy ray-curable functional group other than the 2-(3′,4′-epoxycyclohexyl)ethyl group, the [T3 form/T2 form] can be determined in the same manner. The ²⁹Si-NMR spectrum of the polyorganosilsesquioxane of the present disclosure can be measured, for example, under the same conditions as those for the measurement of the polyorganosiloxane including a silanol group.

The case where the ratio [T3 form/T2 form] of the polyorganosilsesquioxane of the present disclosure is in the above range (e.g., 5 or more and 500 or less) means that a certain amount of the T2 form is present relative to the amount of the T3 form in the polyorganosilsesquioxane of the present disclosure. Examples of such a T2 form include a constituent unit represented by Formula (4) below, a constituent unit represented by Formula (5) below, and a constituent unit represented by Formula (6) below. R¹ in Formula (4) below is the same as R¹ in Formula (1) above, and R² in Formula (5) below is the same as R² in Formula (2) above. R^{c} in Formulas (4) to (6) below represents a hydrogen atom or an alkyl group having from 1 to 4 carbons in the same manner as R^{c} in Formula (II).

[Chem. 14]

[R¹SiO_{2/2}(OR^{c})] (4)

[Chem. 15]

[R²SiO_{2/2}(OR^{c})] (5)

[Chem. 16]

[HSiO_{2/2}(OR^{c})] (6)

The polyorganosilsesquioxane of the present disclosure may have any silsesquioxane structure of a cage-type, an incomplete cage-type, a ladder-type, or a random-type or may have a combination of two or more of these silsesquioxane structures.

In the case where the polyorganosilsesquioxane of the present disclosure has a constituent unit represented by Formula (4) above, the ratio (total amount) of the constituent unit represented by Formula (1) above and the constituent unit represented by Formula (4) above to a total amount (100 mol %) of siloxane constituent units [all siloxane constituent units; a the total amount of the M unit, the D unit, the T unit, and the Q unit] is not particularly limited but is preferably from 55 to 100 mol %, more preferably from 65 to 100 mol %, and even more preferably from 80 to 99 mol %. Adjusting the ratio to 55 mol % or more improves the curability of the hard coating agent and also significantly increases the scratch resistance and toughness of the cured product (coating film). In addition, the ratio of each siloxane constituent unit in the polyorganosilsesquioxane of the present disclosure can be calculated, for example, from the composition of the raw materials or by NMR spectroscopic measurements.

The ratio (total amount) of the constituent unit represented by Formula (2) above and the constituent unit represented by Formula (5) above to a total amount (100 mol %) of siloxane constituent units [all siloxane constituent units; a total amount of the M unit, the D unit, the T unit, and the Q unit] in the polyorganosilsesquioxane of the present disclosure is not particularly limited but is preferably from 0 to 70 mol %, more preferably from 0 to 60 mol %, even more preferably from 0 to 40 mol %, and particularly preferably from 1 to 15 mol %. Adjusting the ratio to 70 mol % or less can relatively increase the ratio of the constituent unit represented by Formula (1) and the constituent unit represented by Formula (4), thus resulting in tendency to improve the curability of the hard coating agent and further increase the scratch resistance and toughness of the cured product (coating film).

The ratio (total amount) of the constituent unit represented by Formula (1) above, the constituent unit represented by Formula (2) above, the constituent unit represented by Formula (4) above, and the constituent unit represented by Formula (5) above to a total amount (100 mol %) of siloxane constituent units [all siloxane constituent units; the total amount of the M unit, the D unit, the T unit, and the Q unit] in the polyorganosilsesquioxane of the present disclosure is not particularly limited but is preferably from 60 to 100 mol %, more preferably from 70 to 100 mol %, and even more preferably from 80 to 100 mol %. Adjusting the ratio to 60 mol % or more tends to further increase the scratch resistance and toughness of the cured product (coating film).

The number average molecular weight (Mn) of the polyorganosilsesquioxane of the present disclosure determined by gel permeation chromatography and calibrated with standard polystyrene is not particularly limited but, for example, can be appropriately selected from a range of 1000 to 50000. The lower limit value of the number average molecular weight is preferably 1500, more preferably 1800, and even more preferably 2000. Adjusting the number average molecular weight to 1000 or more tends to further improve the scratch resistance and toughness of the cured product (coating film). On the other hand, the upper limit value of the number average molecular weight is preferably 50000, more preferably 10000, and even more preferably 8000. Adjusting the number average molecular weight to 50000 or less (e.g., 3000 or less) tends to improve the miscibility with other components in the hard coating agent and improve the scratch resistance and toughness of the cured product (coating film).

The molecular weight dispersity (Mw/Mn) of the polyorganosilsesquioxane of the present disclosure determined by gel permeation chromatography and calibrated with standard polystyrene is not particularly limited but can be appropriately selected from a range of 1.0 to 4.0. The lower limit value of the molecular weight dispersity is preferably 1.0, more preferably 1.1, and even more preferably 1.2. Adjusting the molecular weight dispersity to 1.1 or more tends to make it easier for the hard coating agent to become a liquid and to improve handling properties. On the other hand, the upper limit value of the molecular weight dispersity is preferably 4.0, more preferably 3.0, and even more preferably 2.5. Adjusting the molecular weight dispersity to 4.0 or less tends to further increase the scratch resistance and toughness of the cured product (coating film).

The number average molecular weight and the molecular weight dispersity of the polyorganosilsesquioxane of the present disclosure can be measured with the following instruments and conditions.
Measuring instrument: trade name “LC-20AD” (available from Shimadzu Corporation)
   Column: Shodex KF-801×2 pieces, KF-802, and KF-803 (available from Showa Denko K.K.)
   Measurement temperature: 40° C.
   Eluent: THF, sample concentration from 0.1 to 0.2 mass %
   Flow rate: 1 mL/min
   Detector: UV-VIS detector (trade name “SPD-20A”, available from Shimadzu Corporation)
   Molecular weight: calibrated with standard polystyrene

A 5% weight loss temperature (T_{d5}) of the polyorganosilsesquioxane of the present disclosure in an air atmosphere is not particularly limited but is preferably 330° C. or higher (e.g., from 330 to 450° C.), more preferably 340° C. or higher, and even more preferably 350° C. or higher. With the 5% weight loss temperature of 330° C. or higher, the scratch resistance and toughness of the cured product (coating film) tend to further improve. In particular, in the polyorganosilsesquioxane of the present disclosure, with the ratio [T3 form/T2 form] of 5 or more and 500 or less, the number average molecular weight of 1000 to 50000, and the molecular weight dispersity of 1.0 to 4.0, the 5% weight loss temperature is controlled to 330° C. or higher. The 5% weight loss temperature is a temperature at which the weight decreases by 5% of the weight before heating when heating is performed at a constant temperature increase rate, and is an index of heat resistance. The 5% weight loss temperature can be measured by thermogravimetric analysis (TGA) under conditions of a temperature increase rate of 5° C./min in an air atmosphere.

The proportion of a silanol group in the polyorganosilsesquioxane of the present disclosure measured by the same method as described above is preferably from 0.1 to 5%, more preferably from 0.5 to 4%, and even more preferably from 1 to 3%. When the proportion of a silanol group in the polyorganosilsesquioxane of the present disclosure is 0.1% or more, adhesion to the undercoat layer is easily realized.

The polyorganosilsesquioxane of the present disclosure can be produced by a known or commonly used method for producing a polysiloxane. The method is not particularly limited, but for example, the polyorganosilsesquioxane can be produced by a method of subjecting one or two or more hydrolyzable silane compounds to hydrolysis and condensation.

The polyorganosilsesquioxane of the present disclosure has the configuration described above, and thus the hard coat layer containing the polyorganosilsesquioxane has excellent scratch resistance and toughness.

In the hard coating agent, one type of polyorganosilsesquioxane of the present disclosure can be used alone, or two or more types can be used. That is, the hard coat layer may contain one type of polyorganosilsesquioxane of the present disclosure alone or may contain two or more types of polyorganosilsesquioxanes of the present disclosure.

The content (blended amount) of the curing-type polyorganosilsesquioxane resin in the hard coat layer is not particularly limited but is preferably 70 mass % or more and less than 100 mass %, more preferably from 80 to 99.8 mass %, and even more preferably from 90 to 99.5 mass % per a total amount (total amount of the hard coating agent excluding a solvent; 100 mass %) of the hard coat layer. Adjusting the content of the curing-type polyorganosilsesquioxane resin to 70 mass % or more tends to further improve the scratch resistance and toughness of the cured product (coating film). On the other hand, adjusting the content of the curing-type polyorganosilsesquioxane resin to less than 100 mass % allows the hard coat layer to contain a curing agent, resulting in tendency to enable the curing to more efficiently proceed.

The ratio of the polyorganosilsesquioxane of the present disclosure to a total amount (100 mass %) of a photocationically curable compound and a photoradically curable compound contained in the hard coating agent is not particularly limited but is preferably from 70 to 100 mass %, more preferably from 75 to 98 mass %, and even more preferably from 80 to 95 mass %. Adjusting the ratio of the polyorganosilsesquioxane of the present disclosure to 70 mass % or more tends to further improve the scratch resistance and toughness of the cured product (coating film). In the case where the hard coating agent contains only one of the photocationically curable compound or the photoradically curable compound, its ratio to the total amount is shown.

The hard coating agent preferably further contains a curing agent to promote curing reaction by radiation with an activated energy ray. From the viewpoint of shortening the curing time until the hard coating agent becomes tack free, the hard coating agent particularly preferably contains, among others, a photocationic polymerization initiator and/or a photoradical polymerization initiator as the curing agent.

For the photocationic polymerization initiator, the same compound as those disclosed for the curable composition described above can be used.

The photoradical polymerization initiator is a compound that can initiate or promote photoradical polymerization reaction of a photoradically curable compound, such as the polyorganosilsesquioxane of the present disclosure. Examples of the photoradical polymerization initiator include an alkylphenone-based photoradical polymerization initiator, an acylphosphine oxide-based photoradical polymerization initiator, an oxime ester-based photoradical polymerization initiator, and an a-hydroxy ketone-based photoradical polymerization initiator.

In the hard coating agent, one type of the curing agents can be used alone, or two or more types can be used.

The content (blended amount) of the curing agent in the hard coating agent is not particularly limited but is preferably from 0.01 to 10.0 parts by mass, more preferably from 0.05 to 5.0 parts by mass, and even more preferably from 0.1 to 3.0 parts by mass per a total amount of the polyorganosilsesquioxane of the present disclosure and an additional active energy ray-curable compound described later (100 parts by mass; a total amount of active energy ray-curable compounds). Adjusting the content of the curing agent to 0.01 parts by mass or more allows the curing reaction to efficiently and sufficiently proceed and tends to further improve the scratch resistance and toughness of the cured product (coating film). On the other hand, adjusting the content of the curing agent to 5.0 parts by mass or less tends to further improve the storage properties of the hard coating agent and to prevent coloration of the cured product (coating film).

The hard coating agent may further contain an active energy ray-curable compound (which may be referred to as an “additional active energy ray-curable compound”) besides the polyorganosilsesquioxane of the present disclosure. Examples of the additional active energy ray-curable compound include a photocationically curable compound (which may be referred to as an “additional photocationically curable compound”) besides the polyorganosilsesquioxane of the present disclosure and/or a photoradically curable compound (which may be referred to as an “additional photoradically curable compound”) besides the polyorganosilsesquioxane of the present disclosure.

For the additional photocationically curable compound, a known or commonly used photocationically curable compound can be used and is not particularly limited. However, examples include an epoxy compound other than the polyorganosilsesquioxane of the present disclosure, an oxetane compound, and a vinyl ether compound. In the hard coating agent, one type of additional photocationically curable compound can be used alone, or two or more types of additional photocationically curable compounds can be used.

Examples of the epoxy compound and the oxetane compound include the same compounds as those described in the curable composition.

In the hard coating agent, an epoxy compound is preferably used as an additional photocationically curable compound in combination with the polyorganosilsesquioxane of the present disclosure.

For the additional photoradically curable compound, a known or commonly used photoradically curable compound can be used and is not particularly limited. However, examples include a compound other than the polyorganosilsesquioxane of the present disclosure, the compound having one or more photoradically polymerizable groups per molecule, the photoradically polymerizable group, such as a (meth)acrylic group, a (meth)acryloxy group, a (meth)acrylamino group, a vinyl ether group, a vinylaryl group, or a vinyloxy carbonyl group. In the hard coating agent, one type of additional photoradically curable compound can be used alone, or two or more types of additional photoradically curable compounds can be used.

In the case where the hard coating agent contains an additional active energy ray-curable compound, the content (blended amount) is not particularly limited but is preferably from 3 to 50 mass %, more preferably from 5 to 40 mass %, and even more preferably from 7 to 30 mass % per a total amount of the polyorganosilsesquioxane of the present disclosure and the additional active energy ray-curable compound (100 mass %; a total amount of the active energy ray-curable compounds). Adjusting the content of the additional active energy ray-curable compound to 50 mass % or less tends to further improve the scratch resistance and toughness of the cured product (coating film). On the other hand, adjusting the content of the additional active energy ray-curable compound to 3 mass % or more may make it possible to impart desired performance (e.g., such as fast curing properties and viscosity adjustment for the hard coating agent) to the hard coating agent and/or cured product (coating film).

The hard coating agent preferably contains a compound (which may be referred to as “the compound A”) having one or more thermally-polymerizable functional groups and one or more photopolymerizable functional groups per molecule. The hard coating agent containing the compound A together with the polyorganosilsesquioxane of the present disclosure can effectively increase the crosslink density when formed into a cured product and makes it easier to impart high surface hardness to the cured product (coating film).

The “thermally-polymerizable functional group” in the compound A is not particularly limited as long as it is a functional group that imparts polymerizability by heat to the compound A but examples include a hydroxy group, an epoxy group, an oxetanyl group, and a vinyl ether group. From the viewpoint of surface hardness of the coating film of the present disclosure, a hydroxy group or an epoxy group is preferred. In the case where the compound A has two or more thermally-polymerizable functional groups, these thermally-polymerizable functional groups each may be the same or different.

The “photopolymerizable functional group” in the compound A is not particularly limited as long as it is a functional group that imparts polymerizability by light (e.g., ultraviolet light) to the compound A but examples include a (meth)acryloyl group and a vinyl group. From the viewpoint of surface hardness of the coating film of the present disclosure, a (meth)acryloyl group is preferred. In the case where the compound A has two or more photopolymerizable functional groups, these photopolymerizable functional groups each may be the same or different.

The number of the thermally-polymerizable functional group the compound A has per molecule is not particularly limited as long as it is one or more but, for example, is preferably from 1 to 5, more preferably from 1 to 3, and even more preferably 1 or 2. In addition, the number of the photopolymerizable functional group the compound A has per molecule is not particularly limited as long as it is one or more but, for example, is preferably from 1 to 5, more preferably from 1 to 3, and even more preferably 1 or 2.

The functional group equivalent of the thermally-polymerizable functional group of the compound A is not particularly limited but is preferably from 50 to 500, more preferably from 80 to 480, and even more preferably from 120 to 450. With the functional group equivalent of less than 50, the cured product (coating film) would be insufficient. On the other hand, with the functional group equivalent of more than 500, the surface hardness of the cured product (coating film) would decrease. The functional group equivalent of the thermally-polymerizable functional group of the compound A can be calculated by the following equation.

[Functional group equivalent of thermally-polymerizable functional group]=[molecular weight of compound A]/[number of thermally-polymerizable functional group contained in compound A]

The functional group equivalent of the photopolymerizable functional group of the compound A is not particularly limited but is preferably from 50 to 500, more preferably from 80 to 480, and even more preferably from 120 to 450. When the functional group equivalent is less than 50, the cured product (coating film) would be insufficient. On the other hand, when the functional group equivalent is more than 500, the surface hardness of the cured product (coating film) would decrease. The functional group equivalent of the photopolymerizable functional group of the compound A can be calculated by the following equation.

[Functional group equivalent of photopolymerizable functional group]=[molecular weight of compound A]/[number of photopolymerizable functional group contained in compound A]

Specific examples of the compound A include a compound having an epoxy group and/or a hydroxy group and a (meth)acryloyl group per molecule, such as 3,4-epoxycyclohexylmethyl (meth)acrylate, glycidyl (meth)acrylate, tripropylene glycol diglycidyl ether di(meth)acrylate (a compound obtained by reacting (meth)acrylic acid with both epoxy groups of tripropylene glycol diglycidyl ether), tripropylene glycol diglycidyl ether half (meth)acrylate (a compound obtained by reacting (meth)acrylic acid with one epoxy group of tripropylene glycol diglycidyl ether), bisphenol A epoxy di(meth)acrylate (a compound obtained by reacting (meth)acrylic acid with both epoxy groups of bisphenol A diglycidyl ether), bisphenol A epoxy half (meth)acrylate (a compound obtained by reacting (meth)acrylic acid or its derivative with one epoxy group of bisphenol A diglycidyl ether), bisphenol F epoxy di(meth)acrylate, bisphenol F epoxy half (meth)acrylate, bisphenol S epoxy di(meth)acrylate, and bisphenol S epoxy half (meth)acrylate; a compound having an oxetanyl group and a (meth)acryloyl group per molecule, such as 3-oxetanyl methyl (meth)acrylate, 3-methyl-3-oxetanyl methyl (meth)acrylate, 3-ethyl-3-oxetanyl methyl (meth)acrylate, 3-butyl-3-oxetanyl methyl (meth)acrylate, and 3-hexyl-3-oxetanyl methyl (meth)acrylate; and a compound having a vinyl ether group and a (meth)acryloyl group per molecule, such as 2-vinyloxy ethyl (meth)acrylate, 3-vinyloxy propyl (meth)acrylate, 1-methyl-2-vinyloxy ethyl (meth)acrylate, 2-vinyloxy propyl (meth)acrylate, 4-vinyloxy butyl (meth)acrylate, 1-methyl-3-vinyloxy propyl (meth)acrylate, 1-vinyloxy methylpropyl (meth)acrylate, 2-methyl-3-vinyloxy propyl (meth)acrylate, 1,1-dimethyl-2-vinyloxy ethyl (meth)acrylate, 3-vinyloxy butyl (meth)acrylate, 1-methyl-2-vinyloxy propyl (meth)acrylate, 2-vinyloxy butyl (meth)acrylate, 4-vinyloxy cyclohexyl (meth)acrylate, 6-vinyloxy hexyl (meth)acrylate, 4-vinyloxy methylcyclohexyl methyl (meth)acrylate, 3-vinyloxy methylcyclohexyl methyl (meth)acrylate, 2-vinyloxy cyclohexyl methyl (meth)acrylate, p-vinyloxy methylphenyl methyl (meth)acrylate, m-vinyloxy methylphenyl methyl (meth)acrylate, o-vinyloxy methylphenyl methyl (meth)acrylate, 2-(vinyloxyethoxy)ethyl (meth)acrylate, 2-(vinyloxyisopropoxy)ethyl (meth)acrylate, 2-(vinyloxyethoxy)propyl (meth)acrylate, 2-(vinyloxyethoxy)isopropyl (meth)acrylate, 2-(vinyloxyisopropoxy)propyl (meth)acrylate, 2-(vinyloxyisopropoxy)isopropyl (meth)acrylate, 2-(vinyloxyethoxyethoxy)ethyl (meth)acrylate, 2-(vinyloxyethoxyisopropoxy)ethyl (meth)acrylate, 2-(vinyloxyisopropoxyethoxy)ethyl (meth)acrylate, 2-(vinyloxyisopropoxyisopropoxy)ethyl (meth)acrylate, 2-(vinyloxyethoxyethoxy)propyl (meth)acrylate, 2-(vinyloxyethoxyisopropoxy)propyl (meth)acrylate, 2-(vinyloxyisopropoxyethoxy)propyl (meth)acrylate, 2-(vinyloxyisopropoxyisopropoxy)propyl (meth)acrylate, 2-(vinyloxyethoxyethoxy)isopropyl (meth)acrylate, 2-(vinyloxyethoxyisopropoxy)isopropyl (meth)acrylate, 2-(vinyloxyisopropoxyethoxy)isopropyl (meth)acrylate, 2-(vinyloxyisopropoxyisopropoxy)isopropyl (meth)acrylate, 2-(vinyloxyethoxyethoxyethoxy)ethyl (meth)acrylate, 2-(vinyloxyethoxyethoxyethoxyethoxy)ethyl (meth)acrylate, 2-(isopropenoxyethoxy)ethyl (meth)acrylate, 2-(isopropenoxyethoxyethoxy)ethyl (meth)acrylate, 2-(isopropenoxyethoxyethoxyethoxy)ethyl (meth)acrylate, 2-(isopropenoxyethoxyethoxyethoxyethoxy)ethyl (meth)acrylate, polyethylene glycol monovinyl ether (meth)acrylate, and polypropylene glycol monovinyl ether (meth)acrylate.

From the viewpoint of the surface hardness of the cured product (coating film), the compound A is preferably a compound having, per molecule, an epoxy group and/or a hydroxy group as a thermally-polymerizable functional group and a (meth)acryloyl group as a photopolymerizable functional group, and specifically preferably 3,4-epoxycyclohexylmethyl (meth)acrylate, glycidyl (meth)acrylate, tripropylene glycol diglycidyl ether half (meth)acrylate, bisphenol A epoxy half (meth)acrylate, bisphenol F epoxy half (meth)acrylate, bisphenol S epoxy half (meth)acrylate, or the like.

In the hard coating agent, one compound A can be used alone, or two or more compounds A can be used. The compound A can be produced by a known method and is obtained, for example, by a method of reacting some of the thermally-polymerizable functional groups of a compound having two or more thermally-polymerizable functional groups (e.g., an epoxy group and/or a hydroxy group) per molecule with a carboxylic acid (e.g., such as acrylic acid or methacrylic acid) having a photopolymerizable functional group or its derivative.

The content (blended amount) of the compound A in the hard coating agent is not particularly limited but, as a solid content, is preferably from 1.0 to 100 parts by mass, more preferably from 1.3 to 75 parts by mass, and even more preferably from 1.5 to 50 parts by mass per a total amount of 100 parts by mass of the polyorganosilsesquioxane of the present disclosure and an additional active energy ray-curable compound (a total amount of the active energy ray-curable compounds). Adjusting the content of the compound A to 1 part by mass or more tends to further improve the cured product (coating film). On the other hand, adjusting the content of the compound A to 100 parts by mass or less tends to be able to maintain the surface hardness of the cured product (coating film).

The hard coating agent preferably contains a surface control agent. For the surface control agent, a known or commonly used compound to be added for the purpose of antifoaming, leveling, anti-popping, or the like can be used. For the antifoaming agent, leveling agent, or anti-popping agent, for example, an aqueous or non-aqueous compound composed of a main component selected from polymer main components, such as butadiene, acryl, and olefin, or silicone-based main components, such as silicone and fluorine-modified silicone, can be used. Among these, a radically curable polyorganosiloxane is preferably included as the aqueous or non-aqueous compound composed of a main component selected from the silicone-based main components. Using the radically curable polyorganosiloxane improves the smoothness of the hard coat layer surface, provides excellent sebum adhesion resistance, and makes it hard for a fingerprint to attach to the surface. In addition, the radically curable polyorganosiloxane is preferably not a compound corresponding to a PFAS. In this case, even though not included in the compounds corresponding to PFASs, the radically curable polyorganosiloxane exhibits the effects described above. The radically curable polyorganosiloxane has radical curability and thus also corresponds to the curable compound. One type of the radically curable polyorganosiloxanes may be used alone, or two or more may be used.

The radically curable polyorganosiloxane has a radically polymerizable functional group in the molecule. Examples of the radically curable functional group include a photoradically polymerizable functional group.

Examples of the photoradically polymerizable functional group include a (meth)acryloyl group, a (meth)acrylamide group, a vinyl group, and a vinylthio group. Among these, a (meth)acryloyl group is preferred.

The polyorganosiloxane in the radically curable polyorganosiloxane is preferably a linear polyorganosiloxane from the viewpoint of its effect as a leveling agent.

The content (blended amount) of the surface control agent in the hard coating agent is not particularly limited but, as a solid content, is, for example, from 0.01 to parts by mass, preferably from 0.05 to 10 parts by mass, more preferably from 0.1 to 5 parts by mass, and even more preferably from 0.2 to 3 parts by mass per a total amount of 100 parts by mass of the polyorganosilsesquioxane of the present disclosure and an additional active energy ray-curable compound (a total amount of the active energy ray-curable compounds). Adjusting the content of the surface control agent to 0.01 parts by mass or more tends to further improve the leveling properties of the cured product (coating film).

The hard coating agent preferably contains an antioxidant. Containing an antioxidant, the hard coating agent tends to further improve the surface hardness of the cured product (coating film). One type of the antioxidants may be used alone, or two or more types may be used.

For the antioxidant, the same antioxidant as those exemplified for the photocurable compound described above can be used.

In the case where the hard coating agent contains an antioxidant, the content (blended amount) is not particularly limited but is preferably from 0.05 to 5 parts by mass and more preferably from 0.1 to 3 parts by mass per a total amount (100 parts by mass) of the active energy ray-curable compounds contained in the hard coating agent. The content of the antioxidant of 0.05 parts by mass or more makes it easier to provide sufficient storage stability of the cured product (coating film). On the other hand, when the content of the antioxidant is 5 parts by mass or less, the coloration of the cured product (coating film) can be prevented.

The hard coating agent may preferably further contain a solvent. The solvent is not particularly limited as long as it can dissolve the polyorganosilsesquioxane of the present disclosure and an additive used as necessary and does not inhibit polymerization. One type of the solvents may be used alone, or two or more types may be used.

The solvent preferably used is a solvent that can impart fluidity suitable for application to the hard coat layer and can be easily removed by heating at a temperature at which the progression of polymerization can be suppressed. One or two or more types of solvents with a boiling point (at 1 atm) of 170° C. or lower (e.g., an aromatic solvent, such as toluene, xylene, or mesitylene; an ester, such as butyl acetate; a ketone, such as methyl isobutyl ketone or cyclohexanone; or an ether, such as propylene glycol monomethyl ether or propylene glycol monomethyl ether acetate) are preferably used.

In terms of excellent coating properties, the solvent is preferably used in such a range that the concentration of the non-volatile content contained in the hard coating agent is, for example, about from 5 to 100 mass %, preferably from 10 to 80 mass %, and particularly preferably from 20 to 70 mass %. However, the addition amount is not limited to the above ranges, as an optimal addition amount should be selected such that a viscosity is adjusted to achieve an appropriate film thickness. That is, using an excess amount of the solvent would reduce the viscosity of the hard coating agent and tend to make it difficult to form a coating film with an appropriate film thickness. On the other hand, using too small an amount of the solvent would increase the viscosity of the hard coating agent excessively and tend to make it difficult to uniformly apply the hard coating agent to an alternative glass substrate.

The hard coating agent may further contain a commonly used additive as an additional optional component including an inorganic filler, such as precipitated silica, wet silica, fumed silica, calcined silica, titanium oxide, alumina, glass, quartz, aluminosilicic acid, iron oxide, zinc oxide, calcium carbonate, carbon black, silicon carbide, silicon nitride, or boron nitride; an inorganic filler obtained by treating a filler of these with an organosilicon compound, such as an organohalosilane, organoalkoxysilane, or organosilazane; an organic resin fine powder, such as a silicone resin, an epoxy resin, or a fluororesin; a filler, such as a conductive metal powder of silver, copper, or the like, a curing auxiliary, a stabilizer (such as a light-resistant stabilizer, a heat stabilizer, or a heavy metal inactivator), an ultraviolet absorber (a triazine-based ultraviolet absorber, a benzotriazole-based ultraviolet absorber, a benzophenone-based ultraviolet absorber, an oxybenzophenone-based ultraviolet absorber, a salicylic acid ester-based ultraviolet absorber, or a cyanoacrylate-based ultraviolet absorber), a flame retardant (such as a phosphorus-based flame retardant, a halogen-based flame retardant, or an inorganic flame retardant), a flame retardant auxiliary, a reinforcing material (such as an additional filler), a nucleating agent, a coupling agent (such as a silane coupling agent), a lubricant, a wax, a plasticizer, a release agent, an impact modifier, a hue modifier, a transparentizing agent, a rheology modifier (such as a fluidity modifier), a workability modifier, a colorant (such as a dye or a pigment), an antistatic agent, a dispersant, a surface modifier (such as a slip agent), a matting agent, an antifoaming agent, a foam inhibitor, a defoamer, an antibacterial agent, a preservative, a viscosity modifier, a thickener, a photosensitizer, or a foaming agent. One type of these additives can be used alone, or two or more types can be used.

In addition, the hard coating agent preferably contains no compound corresponding to a PFAS. That is, the hard coat layer containing the hard coating agent preferably contains no compound corresponding to a PFAS. Having the above configuration eliminates the use of a compound corresponding to a PFAS and enables the hard coating agent and the hard coat layer to be compliant with environmental regulations and to have excellent safety.

The hard coating agent can be prepared by stirring and mixing the components described above at room temperature or with heating as necessary although the preparation is not particularly limited. For the hard coating agent, a one-part composition, which is prepared by mixing components in advance and used as is, can be used, or alternatively, a multi-part (e.g., two-part) composition, which constitutes two or more components stored separately and is prepared by mixing the components at a given ratio before use, can be used.

The hard coating agent is preferably a liquid at normal temperature (about 25° C.) although this is not particularly limited. More specifically, a liquid in which the hard coating agent is diluted in 20% of a solvent [in particular, a hard coating agent solution with a ratio of methyl isobutyl ketone of 20 mass %] has a viscosity at 25° C. of preferably from 300 to 20000 mPa·s, more preferably from 500 to 10000 mPa·s, and even more preferably from 1000 to 8000 mPa·s. Adjusting the viscosity to 300 mPa·s or more tends to further improve the cured product (coating film). On the other hand, adjusting the viscosity to 20000 mPa·s or less facilitates the preparation and handling of the hard coating agent and tends to less likely to leave residual bubbles in the cured product (coating film). The viscosity of the hard coating agent is measured using a viscometer (trade name “MCR301”, available from Anton Paar GmbH) under conditions of a swing angle of 5%, a frequency of 0.1 to 100 (1/s), and a temperature of 25° C.

A laminate with a three-layer structure of a substrate, an undercoat layer, and a hard coat layer can be produced by applying the prepared hard coating agent onto the undercoat layer and curing by a known or commonly used method.

Coating and curing of the hard coat layer can be carried out in the same manner as exemplified for the undercoat layer. In the case of curing the hard coat layer by ultraviolet light irradiation, the cumulative irradiation dose is, for example, preferably about from 1 to 5000 mJ/cm².

The specific curing conditions are not particularly limited, but for example, the hard coating agent is first heat-treated (prebaked) at preferably 60° C. or higher, more preferably 120° C. or higher, and even more preferably 150° C. or higher for preferably seconds or more, more preferably 30 seconds or more, and even more preferably 60 seconds or more, then irradiated with ultraviolet light (radiation conditions (radiation dose) preferably of 300 mJ/cm² or more and a radiation intensity of 100 mW/cm² or more), and finally cured by heat treatment (aging) at preferably 120° C. or higher for preferably 0.5 hours or more. However, the curing conditions are not limited to this range, and the prebake temperature and time, and the aging temperature and time can be appropriately selected according to the solvent to be used, and the ultraviolet radiation conditions can be appropriately selected according to the curing agent to be used.

The hard coating agent can form a hard coat layer with high scratch resistance, surface hardness, and toughness by application and curing as described above. The laminate thus produced has excellent adhesion and can improve the surface hardness of the hard coat layer.

The thickness of the hard coat layer is preferably from 0.5 to 50 μm, more preferably from 1 to 40 μm, and particularly preferably from 3 to 30 μm. The thickness of the hard coat layer of 0.5 μm or more makes it easier to improve the surface hardness.

The hard coat layer surface of the laminate preferably does not have perceptible tackiness when the surface is touched by a finger.

The hard coat layer surface of the laminate has a pencil hardness of preferably 3H or more and more preferably 4H or more. The pencil hardness can be evaluated in accordance with the method described in JIS K5600-5-4 (750 g load). When the hard coat layer surface has the pencil hardness of 3H or more, the laminate has sufficient surface hardness and tends to have excellent scratch resistance.

In addition, when cuts are made at intervals of 1 mm on the laminate from the hard coat layer side with a cutter blade to form a lattice pattern of 100 squares, an adhesive tape is attached and peeled off at an angle of 90°, and whether the coating surfaces are peeled off after attaching to the adhesive tape is observed in accordance with JIS K5600-5-6, preferably 90 or more squares, more preferably 95 or more squares, and particularly preferably 100 squares remain intact. When the laminate has 90 or more squares remained intact, it is confirmed that the hard coat layer and the undercoat layer exhibit sufficient adhesion.

### Display Device

An embodiment of the present disclosure includes a display device including the laminate. In the display device, the laminate is disposed, for example, such that the hard coat layer constitutes the surface on the viewing side. The display device is not particularly limited, and examples include a display device, such as an organic electroluminescence display device, an inorganic electroluminescence display device, and a liquid crystal display device. In the display device, the hard coat layer surface has sufficient surface hardness. Thus, scratches are less likely to occur on the surface. In addition, the display device can also be used as a flexible display that can be bent, rolled, and the like.

Each aspect disclosed in the present specification can be combined with any other feature disclosed herein. In addition, each of the configurations, their combinations, and the like in each embodiment is an example, and an addition, an omission, and an additional change can be appropriately made without departing from the spirit of the present disclosure. The present disclosure is not limited by the embodiments and is limited only by the claims.

### EXAMPLES

An embodiment of the present disclosure will be described in detail below based on examples.

### Production Example 1

### Production of Polyorganosilsesquioxane

To a 1000-mL flask (reaction vessel) equipped with a thermometer, a stirrer, a reflux condenser, and a nitrogen inlet tube, 277.2 mmol (68.30 g) of 2-(3,4-epoxycyclohexyl)ethyltrimethoxysilane, 3.0 mmol (0.56 g) of phenyltrimethoxysilane, and 275.4 g of acetone were placed under a nitrogen stream, and the temperature was raised to 50° C. To the mixture thus obtained, 7.74 g of a 5% potassium carbonate aqueous solution (2.8 mmol as potassium carbonate) was added over 5 minutes, and then 2800.0 mmol (50.40 g) of water was added over 20 minutes. No significant temperature increase occurred during the additions. Subsequently, while the temperature was maintained at 50° C., polycondensation reaction was carried out under a nitrogen stream for 5 hours.

Next, at the same time as the reaction solution was cooled, 137.70 g of methyl isobutyl ketone and 100.60 g of a 5% saline solution were added to the solution. This solution was transferred to a 1-L separation funnel, 137.70 g of methyl isobutyl ketone was added again, and the solution was washed with water. After the separation, the water layer was removed, and the lower layer liquid was washed with water until the lower layer liquid became neutral. The upper layer liquid was then fractioned, then the solvent was distilled off from the upper layer liquid under conditions of 1 mmHg and 50° C., and 75.18 g of a colorless, transparent liquid product (an epoxy group-containing low-molecular weight polyorganosilsesquioxane: silsesquioxane of Production Example 1) containing 23 mass % of methyl isobutyl ketone was obtained.

Analysis of the product revealed a number average molecular weight of 2235 and a molecular weight dispersity of 1.54. A ratio of the T2 form and the T3 form [T3 form/T2 form] calculated from the ²⁹Si-NMR spectrum of the product was 11.9. The resulting epoxy group-containing low-molecular weight polyorganosilsesquioxane was confirmed by ¹H-NMR and ²⁹Si-NMR.

The molecular weight of the product was measured with a Shimadzu LC-20AD pump, a Shodex RI 504 detector, Shodex GPC KF 602 and KF 603 columns, a Shodex GPC KF-G guard column, and THF as a solvent under measurement conditions of 40° C. In addition, the ratio of the T2 form and the T3 form [T3 form/T2 form] in the product was measured by ²⁹Si-NMR spectroscopic measurement with a JEOL ECA500 (500 MHz).

### Preparation of Hard Coating Agent

Each material was mixed with the silsesquioxane of Production Example 1 to give a constitution ratio described in Table 1, and a hard coating agent was prepared. The content shown in Table 1 is a blending ratio of each component, where the content values are for solutions for the silsesquioxane of Production Example 1 (active ingredient 77 mass %) and RS-57 (active ingredient 20 mass %), and for active ingredients for other components.

TABLE 1

| | | Constituent ratio |
|---|---|---|
| | Material name | (parts by mass) |
| Curable compound | Silsesquioxane | 62.5 |
| | of Production | |
| | Example 1 | |
| | 200PA-E5 | 1.09 |
| | Epolight 1600 | 5.16 |
| | RS-57 | 0.54 |
| Radical polymerization | CPI310FG | 0.41 |
| initiator | | |
| Cationic polymerization | Omnirad 127 | 0.11 |
| initiator | | |
| Antioxidant | AO-20 | 0.14 |
| Solvent | MIBK | 3.42 |
| | MEK | 26.7 |

Each component shown in Table 1 is described in detail below.
200PA-E5: trade name “Epoxy Ester 200PA-E5”, available from Kyoeisha Chemical Co., Ltd. (Compound having one or more thermally-polymerizable functional groups and one or more photopolymerizable functional groups per molecule)
Epolight 1600N: trade name “Epolight 1600N”, available from Kyoeisha Chemical Co., Ltd. (additional photocationically curable compound)
RS-57: trade name “MEGAFAC RS-57”, available from DIC Corporation (surface control agent)
Omnirad 127: trade name “Omnirad 127”, available from IGM Resins B.V. (photoradical polymerization initiator)
CPI-310FG: trade name “CPI-310FG”, available from San-Apro Ltd. (photocationic polymerization initiator)
ADEKA STAB AO-02: trade name “ADEKA STAB AO-02”, available from ADEKA Corporation (antioxidant)
MIBK: methyl isobutyl ketone (solvent)
MEK: methyl ethyl ketone (solvent)

### Examples 1 to 6 and Comparative Examples 1 to 5

A mixed solution with a blending ratio shown in Table 2 was prepared and used as a curable composition. The curable composition obtained above was applied to a glass substrate (slide glass) using a wire bar #12 to have a thickness after curing of 10 μm and then irradiated with ultraviolet light with an illuminance of 3000 mJ/cm² using an LED lamp. Thereafter, an undercoat layer was produced by heat treatment in an oven at 150° C. for 30 minutes.

Each component listed in Table 2 is described in detail below.
KR-470: trade name “KR-470”, available from Shin-Etsu Chemical Co., Ltd. (organosiloxane containing two or more alicyclic epoxy groups, number average molecular weight 740)
A-1: 3′,4′-epoxycyclohexylmethyl 3,4-epoxycyclohexane carboxylate (alicyclic epoxy compound)
A-2: 3,4,3′,4′-diepoxy bicyclohexyl (alicyclic epoxy compound)
YX7400N: trade name “YX7400N”, available from Mitsubishi Chemical Corporation (aliphatic epoxy compound)
OXT-101: trade name “OXT-101”, available from Toagosei Co., Ltd. (oxetane compound)
SQ502-8: trade name “Compoceran SQ502-8”, available from Arakawa Chemical Industries, Ltd. (polyorganosiloxane including a silanol group with a content of the T1 form of 25%, a content of the T2 form of 63%, and a content of the T3 form of 12%)
E103-D: trade name “Compoceran E103-D”, available from Arakawa Chemical Industries, Ltd. (polyorganosiloxane including a silanol group)
CPI-101A: trade name “CPI-101A”, available from San-Apro Ltd. (photopolymerization initiator)
CPI-100P: trade name “CPI-100P”, available from San-Apro Ltd. (photopolymerization initiator)
PEP-36: trade name “ADEKA STAB PEP-36”, available from ADEKA CORPORATION (antioxidant)
GA-80: trade name “Sumilizer GA-80”, available from Sumitomo Chemical Co., Ltd. (antioxidant)

The hard coating agent produced in Production Example 1 was further applied onto the undercoat layer using a wire bar #24 to have a cured hard coat layer with a thickness after curing of 20 μm. Then, the laminate was allowed to stand in an oven at 80° C. for 1 minute, allowed to stand in an oven at 120° C. for 2 minutes, and then irradiated with ultraviolet light with an illuminance of 300 mJ/cm² using a high-pressure mercury lamp. Thereafter, laminates of Examples 1 to 6 and Comparative Examples 1 to 5 were produced by heat treatment in an oven at 120° C. for 60 minutes to cure the hard coating agent.

### Evaluation

The laminates of Examples 1 to 6 and Comparative Examples 1 to 5 were evaluated as follows, and the results are described in Table 2.

(1) Tackiness after Curing

The tackiness of the surface of each laminate of Examples 1 to 6 and Comparative Examples 1 to 5 was determined by touching the surface with a finger. A surface with tackiness was evaluated as marginal, and a surface without tackiness was evaluated as good.

### (2) Adhesion Test

According to JIS K5600-5-6, cuts were made at intervals of 1 mm to form a lattice pattern of 100 squares on the hard coat layer surface of each laminate of Examples 1 to 6 and Comparative Examples 1 to 5, by scribing the hard coat layer with a cutter blade, and an adhesive tape was attached and peeled off at an angle of 90°. And the coating surfaces were visually observed to determine whether the coating surfaces were peeled off after attaching to the adhesive tape. The hard coat surface was evaluated as excellent when 100 squares were adhered, evaluated as good when 90 or more squares were adhered, and evaluated as poor when less than 90 squares were adhered.

### (3) Pencil Hardness

In accordance with JIS K5600-5-4 (750 g load), the pencil hardness of the hard coat layer surface of each laminate of Examples 1 to 6 and Comparative Examples 1 to 5 was measured.

TABLE 2

| | | Example | Example | Example | Example | Example | Example |
|---|---|---|---|---|---|---|---|
| | | 1 | 2 | 3 | 4 | 5 | 6 |
| Organosiloxane | RR-470 | 40 | 50 | 40 | 50 | 50 | 40 |
| containing two | | | | | | | |
| or more alicyclic | | | | | | | |
| epoxy groups | | | | | | | |
| Alicyclic | A-1 | 50 | 40 | 50 | | | 50 |
| epoxy compound | A-2 | | | | 40 | | |
| Aliphatic | YX7400N | | | 10 | | 40 | |
| epoxy compound | | | | | | | |
| Oxetane compound | OXT-101 | 10 | 10 | | 10 | 10 | 10 |
| Polyorganosiloxane | SQ502-8 | 5 | 5 | 5 | 5 | 5 | |
| having | E103-D | | | | | | 5 |
| silanol group | | | | | | | |
| Photopolymerization | CPI-101A | | | | | | |
| initiator | CPI-100P | 1 | 1 | 1 | 1 | 1 | 1 |
| Antioxidant | PEP-36 | 0.5 | 0.5 | 0.5 | 0.5 | 0.5 | 0.5 |
| | GA-80 | 0.5 | 0.5 | 0.5 | 0.5 | 0.5 | 0.5 |
| Evaluation | Tackiness | Good | Good | Good | Good | Good | Good |
| | after curing | | | | | | |
| | Pencil hardness | 4H | 4H | 3H | 3H | 6H | 4H |
| | Adhesion | Excellent | Excellent | Excellent | Excellent | Excellent | Excellent |

| | | Compar- | Compar- | Compar- | Compar- | Compar- |
|---|---|---|---|---|---|---|
| | | ative | ative | ative | ative | ative |
| | | Example 1 | Example 2 | Example 3 | Example 4 | Example 5 |
| Organosiloxane | RR-470 | 40 | 50 | 40 | 50 | 50 |
| containing two | | | | | | |
| or more alicyclic | | | | | | |
| epoxy groups | | | | | | |
| Alicyclic | A-1 | 50 | 40 | 50 | | |
| epoxy compound | A-2 | | | | | |
| Aliphatic | YX7400N | | | 10 | 40 | 40 |
| epoxy compound | | | | | | |
| Oxetane compound | OXT-101 | 10 | 10 | | 10 | 10 |
| Polyorganosiloxane | SQ502-8 | | | | | |
| having | E103-D | | | | | |
| silanol group | | | | | | |
| Photopolymerization | CPI-101A | 0.5 | 0.5 | 0.5 | 0.5 | |
| initiator | CPI-100P | | | | | 1 |
| Antioxidant | PEP-36 | 0.5 | 0.5 | 0.5 | 0.5 | 0.5 |
| | GA-80 | 0.5 | 0.5 | 0.5 | 0.5 | 0.5 |
| Evaluation | Tackiness | Good | Good | Good | Good | Good |
| | after curing | | | | | |
| | Pencil hardness | 4H | 3H | 2H | 2H | 2H |
| | Adhesion | Poor | Poor | Excellent | Excellent | Excellent |

As shown in Table 2, the results confirmed that the curable composition of the present disclosure exhibits sufficient adhesion and forms a hard coat layer with excellent surface hardness by containing the first epoxy compound that is an organosiloxane containing two or more alicyclic epoxy groups, the second epoxy compound, the polyorganosiloxane including a silanol group, and the third epoxy compound or an oxetane compound (Examples 1 to 6). On the other hand, the laminate containing no polyorganosiloxane including a silanol group resulted in poor adhesion (Comparative Examples 1 and 2), and the laminate with the composition changed to improve the adhesion without containing the polyorganosiloxane including a silanol group resulted in poor surface hardness (Comparative Examples 3 to 5).

Hereinafter, variations of the invention according to the present disclosure will be described.

### Addendum 1

A curable composition containing, as curable compounds, a first epoxy compound that is an organosiloxane containing two or more alicyclic epoxy groups, a second epoxy compound, a polyorganosiloxane containing a silanol group, and a third epoxy compound or an oxetane compound.

### Addendum 2

The curable composition according to addendum 1, containing the first epoxy compound, the second epoxy compound, the polyorganosiloxane containing a silanol group, and the oxetane compound.

### Addendum 3

The curable composition according to addendum 1 or 2, in which a content of the first epoxy compound is from 30 to 70 mass % per a total amount of the curable compounds.

### Addendum 4

The curable composition according to any one of addenda 1 to 3, in which a content of the second epoxy compound is from 20 to 60 mass % per a total amount of the curable compounds.

### Addendum 5

The curable composition according to any one of addenda 1 to 4, in which a content of the oxetane compound is from 5 to 25 mass % per a total amount of the curable compounds.

### Addendum 6

The curable composition according to any one of addenda 1 to 5, in which a content of the polyorganosiloxane including a silanol group is from 1 to 15 mass % per a total amount of the curable compounds.

### Addendum 7

The curable composition according to any one of addenda 1 to 6, containing no deleterious substance.

### Addendum 8

The curable composition according to any one of addenda 1 to 7, containing no compound corresponding to a PFAS.

### Addendum 9

An undercoat layer containing a cured product of the curable composition described in any one of addenda 1 to 8.

### Addendum 10

The undercoat layer according to addendum 9, having a thickness of 0.1 to 20 μm.

### Addendum 11

A laminate, in which a substrate, the undercoat layer described in addendum 9 or 10 formed on at least one surface of the substrate, and a hard coat layer are laminated in this order.

### Addendum 12

The laminate according to addendum 11, in which the substrate is a glass substrate.

### Addendum 13

The laminate according to addendum 11 or 12, in which the hard coat layer contains a curing-type polyorganosilsesquioxane resin as a curing-type resin.

### Addendum 14

The laminate according to any one of addenda 11 to 13, in which pencil hardness of the hard coat layer surface is 3H or more.

### Addendum 15

The laminate according to any one of addenda 11 to 14, in which when cuts are made at intervals of 1 mm to form a lattice pattern of 100 squares on the surface of the hard coat layer, and an adhesive tape is attached and peeled off at an angle of 90°, 90 or more squares remain intact.

### Addendum 16

The laminate according to any one of addenda 11 to 15, in which the hard coat layer contains no compound corresponding to a PFAS.

### Addendum 17

A display device including the laminate described in any one of addenda 11 to 16.

1. A curable composition comprising, as curable compounds, a first epoxy compound that is an organosiloxane including two or more alicyclic epoxy groups, a second epoxy compound, a polyorganosiloxane including a silanol group, and a third epoxy compound or an oxetane compound.

2. The curable composition according to claim 1, comprising the first epoxy compound, the second epoxy compound, the polyorganosiloxane comprising a silanol group, and the oxetane compound.

3. The curable composition according to claim 1, wherein a content of the first epoxy compound is from 30 to 70 mass % per a total amount of the curable compounds.

4. The curable composition according to claim 1, wherein a content of the second epoxy compound is from 20 to 60 mass % per a total amount of the curable compounds.

5. The curable composition according to claim 1, wherein a content of the oxetane compound is from 5 to 25 mass % per a total amount of the curable compounds.

6. The curable composition according to claim 1, wherein a content of the polyorganosiloxane including a silanol group is from 1 to 15 mass % per a total amount of the curable compounds.

7. The curable composition according to claim 1, comprising no deleterious substance.

8. The curable composition according to claim 1, comprising no compound corresponding to a PFAS.

9. An undercoat layer comprising a cured product of the curable composition described in claim 1.

10. The undercoat layer according to claim 9, comprising a thickness of 0.1 to 20 μm.

11. A laminate comprising a substrate, the undercoat layer described in claim 9 formed on at least one surface of the substrate, and a hard coat layer laminated in this order.

12. The laminate according to claim 11, wherein the substrate is a glass substrate.

13. The laminate according to claim 11, wherein the hard coat layer includes a curing-type polyorganosilsesquioxane resin as a curing-type resin.

14. The laminate according to claim 11, wherein a pencil hardness of the hard coat layer surface is 3H or more.

15. The laminate according to claim 11, wherein when cuts are made at intervals of 1 mm to form a lattice pattern of 100 squares on the surface of the hard coat layer, and an adhesive tape is attached and peeled off at an angle of 90°, 90 or more squares remain intact.

16. The laminate according to claim 11, wherein the hard coat layer includes no compound corresponding to a PFAS.

17. A display device comprising the laminate described in claim 11.
